(19) United States
(12) Patent Application Publication
(10) Pub. No.: US 2026/0082310 A1
(43) Pub. Date: Mar. 19, 2026

(54) COMMUNICATION METHOD AND APPARATUS, ELECTRONIC DEVICE, AND RELATED PRODUCTS

(71) Applicant: HUAWEI TECHNOLOGIES CO., LTD., Shenzhen (CN)

(72) Inventors: Rojan Chitrakar, Singapore (SG); Lei Huang, Singapore (SG); Bin Qian, Shenzhen (CN); Kuan Wu, Shenzhen (CN); Yunbo Li, Shenzhen (CN); Xun Yang, Singapore (SG)

(73) Assignee: HUAWEI TECHNOLOGIES CO., LTD., Shenzhen (CN)

(21) Appl. No.: 19/398,533

(22) Filed: Nov. 24, 2025

Related U.S. Application Data
(63) Continuation of application No. PCT/CN2023/096692, filed on May 26, 2023.

(51) Int. Cl. H04W 48/10; G01S 13/76; H04W 48/16; H04W 64/00

(52) U.S. Cl. CPC H04W 48/10; G01S 13/765; H04W 48/16; H04W 64/006

(57) ABSTRACT

The present disclosure provides a communication method and apparatus, an electronic device, and related products. The communication method includes: receiving, by an initiator, an advertising-response frame from a responder, where the ADV-RESP frame indicates a number N of the responder to participate in multi-millisecond ranging, N≥1; and transmitting, by the initiator, a start of ranging frame to the responder according to the ADV-RESP frame, where the SOR frame is used to provide a time offset at which a first range-measurement cycle to start. Through the above solution, the initiator acquires the number of the responder to participate in MMS ranging through the ADV-RESP frame transmitted by the responder, and then transmits the SOR frame according to the number of the responder to participate in MMS ranging, thus, the initiator acquires the number of the responder to participate in MMS ranging once a responder transmits the ADV-RESP frame to the initiator.

### CROSS-REFERENCE TO RELATED APPLICATIONS

This application is a continuation of International Application No. PCT/CN2023/096692, filed on May 26, 2023, the disclosure of which is hereby incorporated by reference in its entirety.

### TECHNICAL FIELD

Embodiments of the present disclosure generally relate to the field of Ultra-wideband (UWB) technology and more particularly to a communication method and apparatus, an electronic device, and related products.

### BACKGROUND

Ultra-wideband (UWB) technology is increasingly being used for indoor positioning and other location services such as access control and asset locating. Aside from the traditional ranging use case, other use cases, such as device free sensing, Downlink time difference of arrival (DL-TDOA), long-range ranging, etc., are being actively investigated.

To address the long-range ranging use case, Multi-millisecond (MMS) ranging has been introduced in 802.15.4ab (see 15-21-0409-01-04ab-narrowband-assisted-multi-millisecond-uwb). During the Initialization and Setup phase of MMS ranging, an initiator and a responder may negotiate ranging configuration. For example, the initiator transmits an advertising poll (ADV-POLL) frame while the responder may listen for incoming ADV-POLL frames and respond with an advertising response (ADV-RESP) frame if the responder intends to participate in the MMS ranging.

To ensure the operation of the MMS ranging, it is vital for the initiator to acquire the number of a responder that will participate in the MMS ranging. It thus raises the need of a corresponding resolution.

### SUMMARY

Embodiments of the present disclosure provide communication methods and apparatuses, electronic devices, and related products according to the independent claims.

The foregoing and other objects are achieved by the subject matter of the independent claims. Further embodiments are apparent from the dependent claims, the description and the figures.

Particular embodiments are outlined in the attached independent claims, with other embodiments in the dependent claims.

According to a first aspect, the present disclosure relates to a communication method, including:
receiving, by an initiator, an advertising-response (ADV-RESP) frame from a responder, where the ADV-RESP frame indicates a number N of the responder to participate in multi-millisecond (MMS) ranging, N≥1; and
transmitting, by the initiator, a start of ranging (SOR) frame to the responder according to the ADV-RESP frame, where the SOR frame is used to provide a time offset at which a first range-measurement cycle to start.

In the above communication method, the initiator acquires the number of the responder to participate in MMS ranging through the ADV-RESP frame transmitted by the responder, and then transmits the SOR frame according to the number of the responder to participate in MMS ranging, thus, the initiator acquires the number of the responder to participate in MMS ranging once a responder transmits the ADV-RESP frame to the initiator, which is beneficial for normal operations of MMS ranging.

In an embodiment form of the method according to the first aspect as such, the ADV-RESP frame includes a first indication, and the first indication is used to indicate the number N.

The number N may be indicated in an explicit manner, i.e., the number N is directly indicated by the first indication in the ADV-RESP frame, thereby saving signaling overhead.

In an embodiment form of the method according to the first aspect as such, the ADV-RESP frame includes a second indication, and the second indication is used to indicate a number of a remaining ADV-RESP frame to be transmitted following the ADV-RESP frame, the number of the remaining ADV-RESP frame included in an i-th ADV-RESP frame is N−i, and 1≤i≤N.

The number N may be indicated in an explicit manner, i.e., the number N is indirectly indicated by the second indication in the ADV-RESP frame, where the second indication indicates that the number of the remaining ADV-RESP frame included in an i-th ADV-RESP frame is N−i, in the case that N−i and i are given, the number N may be indirectly acquired. In addition, since the initiator has the knowledge of the number of the remaining ADV-RESP frame, the accuracy of the transmission time of the SOR frame can be improved even when the frame drop occurs.

In an embodiment form of the method according to the first aspect as such, the number N is indicated by a number of the ADV-RESP frame received by the initiator.

The number N may be indicated in an implicit manner, i.e., the number N is indicated by the number of the ADV-RESP frame received by the initiator, thereby saving signaling overhead.

In an embodiment form of the method according to the first aspect as such, N≥2, the receiving, by the initiator, the ADV-RESP frame from the responder includes:
sequentially receiving, by the initiator, N ADV-RESP frames from N responders according to a predetermined order, where the predetermined order is coordinated by the N responders.

The ADV-RESP frames are received one after another in a coordinated fashion, ensuring that the ADV-RESP frames do not collide with each other. When the initiator receives the ADV-RESP frame indicating N responders to participate in MMS ranging, it is alerted that N responders will transmit the ADV-RESP frames and thus refrains from transmitting the SOR frame. Thus, the collision of the ADV-RESP frames with each other or with the SOR frame is prevented.

In an embodiment form of the method according to the first aspect as such, the ADV-RESP frame includes a first indication and a second indication, the first indication is used to indicate the number N, and the second indication is used to indicate a number of a remaining ADV-RESP frame to be transmitted following the ADV-RESP frame, the number of the remaining ADV-RESP frame included in an i-th ADV-RESP frame is N−i, and 1≤i≤N.

The joint indication manner may be suitable for the scenario where only one ADV-RESP frame is transmitted by one responder to the initiator. On one hand, the first indication may indicate the number of responders that will participate in MMS ranging. On the other hand, the second indication may indicate that the number of remaining ADV-RESP frame is 0. Thus, after receiving the ADV-RESP frame including the first indication and the second indication, the initiator may learn that it is time to transmit the SOR frame.

In an embodiment form of the method according to the first aspect as such, N≥2, the ADV-RESP frame further includes a third indication, and the third indication is used to indicate N responders are synchronized with each other.

In the case that one of N responders transmits an ADV-RESP frame with the third indication to the initiator, when receiving the ADV-RESP frame, the initiator will understand that this is the only ADV-RESP frame, and will proceed to transmit the SOR frame.

In an embodiment form of the method according to the first aspect as such, the receiving, by the initiator, the ADV-RESP frame from the responder includes:
receiving, by the initiator, one ADV-RESP frame from one responder, where the one responder is predetermined or dynamically selected from the responder to participate in the MMS ranging.

Only one responder transmits one ADV-RESP frame to the initiator, not multiple responders transmit their ADV-RESP frames to the initiator in the initialization and setup phase, thus the processing efficiency of the initialization and setup phase will be improved, and a unified initialization and setup procedure is achieved.

In an embodiment form of the method according to the first aspect as such, before the receiving, by the initiator, the ADV-RESP frame from the responder, the method further includes:
transmitting, by the initiator, an advertising-poll (ADV-POLL) frame to the responder, where the ADV-POLL frame is used to indicate a maximum number of K responder supported for the MMS ranging, and K≥1.

The maximum number of K responder supported for the MMS ranging may indicate that whether the initiator supports one-to-many MMS ranging or not. When K is a value larger than one, it means that initiator supports one-to-many MMS ranging.

In an embodiment form of the method according to the first aspect as such, the transmitting, by the initiator, the SOR frame to the responder includes:
transmitting, by the initiator, the SOR frame to the responder upon receiving an N-th ADV-RESP frame.

Upon receiving the N-th ADV-RESP frame, that is, the last ADV-RESP frame (that indicates zero remaining ADV-RESP frames), the initiator transmits the SOR frame that indicates when the MMS ranging will start. Thus, the collision of the ADV-RESP frames with each other or with the SOR frame is prevented.

In an embodiment form of the method according to the first aspect as such, the transmitting, by the initiator, the SOR frame to the responder includes:
estimating an expected transmission time of N ADV-RESP frame; and
transmitting, by the initiator, the SOR frame to the responder upon elapse of the expected transmission time.

In case the last ADV-RESP frame is not received by the initiator, once the expected total transmission time for all ADV-RESP frames has elapsed, the initiator transmits the SOR frame. Thus, the collision of the ADV-RESP frames with each other or with the SOR frame is prevented.

In an embodiment form of the method according to the first aspect as such, the transmitting, by the initiator, the SOR frame to the responder includes:
transmitting, by the initiator, the SOR frame to the one responder.

Upon receiving one ADV-RESP frame from the one responder, the initiator determines that only one responder transmits one ADV-RESP frame, and transmits the SOR frame. Thus, the collision of the ADV-RESP frames with each other or with the SOR frame is prevented.

In an embodiment form of the method according to the first aspect as such, before the transmitting, by the initiator, the SOR frame to the responder, the method further includes:
determining, by the initiator, a number M of a responder for MMS ranging according to a number of received ADV-RESP frame, MEN; and
transmitting, by the initiator, the SOR frame including a fourth indication indicating the number M.

Before the start of the MMS ranging, the initiator may select the responder for MMS ranging within the responders that transmit ADV-RESP frames to the initiator.

In an embodiment form of the method according to the first aspect as such, the ADV-RESP frame further includes a fifth indication for indicating that a POLL frame is absent in a ranging control phase other than in a first access slot in the MMS ranging.

The POLL frame is absent in a ranging control phase other than in a first access slot in the MMS ranging, thus one measurement cycle can be completed with less time, and shorter ranging duration can be achieved.

In an embodiment form of the method according to the first aspect as such, the ADV-RESP frame further includes a sixth indication for indicating that an RESP frame is absent in the ranging control phase other than in the first access slot.

The RESP frame is absent in the ranging control phase other than in the first access slot in the MMS ranging, thus one measurement cycle can be completed with less time, and shorter ranging duration can be achieved.

In an embodiment form of the method according to the first aspect as such, the ADV-RESP frame further includes a seventh indication for indicating that the initiator is requested to transmit a measurement report; the method further includes:
transmitting, by the initiator, a report frame.

In an embodiment form of the method according to the first aspect as such, N≥2, and the ADV-RESP frame further includes an eighth indication for requesting a consolidated measurement report; the method further includes:
generating, by the initiator, the consolidated measurement report according to measurements for N responders;
the transmitting, by the initiator, the report frame includes:
transmitting, by the initiator, the report frame carrying the consolidated measurement report.

When the consolidated measurement report is requested, the Measurement Report Phase is not included in the access slots and the initiator reserves slots at the end of the ranging round to transmit consolidated measurement reports from/for all responders that is, it is unnecessary to transmit a measurement report in each access slot, thereby reducing the ranging time, and shorter ranging duration can be achieved.

In an embodiment form of the method according to the first aspect as such, the ADV-RESP frame further includes a ninth indication for requesting a double-sided two-way ranging (DS-TWR) measurement in a measurement report, and a seventh indication for indicating that the initiator is requested to transmit a measurement report is included in the ADV-RESP frame; the method further includes:
transmitting, by the initiator, the measurement report comprising both a first round-trip time and a first reply time.

Both the round-trip time and the reply time are measured by the initiator and DS-TWR is enabled.

In an embodiment form of the method according to the first aspect as such, the ADV-RESP frame further includes a tenth indication for requesting the initiator to transmit an additional MMS packet; the method further includes:
transmitting, by the initiator, the additional MMS packet.

In an embodiment form of the method according to the first aspect as such, an additional MMS packet is not requested in the ADV-RESP frame; the method further includes:
determining, by the initiator, an MMS packet used for the MMS ranging is an MMS packet including a single fragment with a ranging marker;
setting, by the initiator, an eleventh indication for requesting the initiator to transmit an additional MMS packet in the SOR frame to be valid; and
transmitting, by the initiator, the additional MMS packet.

In the scenario where the MMS packet used for the MMS ranging has a single fragment with RMARKER, an additional MMS packet from the initiator may be required to enable DS-TWR. In the case that an additional MMS packet is not requested in the ADV-RESP frame, the Final MMS Packet Requested field in the SOR frame may be set to 1, thus an additional MMS packet from the initiator may still be requested to enable DS-TWR. That is, the initiator may determine to transmit the additional MMS packet according to the type of the MMS packet even when the additional MMS packet is not requested by the responder.

In an embodiment form of the method according to the first aspect as such, the method further includes:
recording, by the initiator, a first transmission time of a first ranging marker of a first fragment of a first MMS packet from the initiator to an N-th responder, a first reception time of a second ranging marker of a first fragment of a second MMS packet from the N-th responder to the initiator, and a second transmission time of a third ranging marker of a first fragment of the additional MMS packet; and
computing, by the initiator, the first round-trip time and the first reply time according to the first transmission time, the first reception time, and the second transmission time.

The DS-TWR for the N-th responder (last responder) can be enabled based on the additional MMS packet when an MMS packet used for the MMS ranging is an MMS packet including a single fragment with a ranging marker.

In an embodiment form of the method according to the first aspect as such, the ADV-RESP frame further includes a twelfth indication for requesting to reverse fragment interleaving in a last access slot in the MMS ranging; the method further includes:
transmitting, by the initiator, an MMS packet in the last access slot after receiving a first fragment of an MMS packet transmitted by an N-th responder.

Through reversing the order of the MMS packet exchange in the last access slot, an additional MMS packet from the initiator may be unnecessary, and DS-TWR can still be enabled.

In an embodiment form of the method according to the first aspect as such, reversing of fragment interleaving in a last access slot in the MMS ranging is not requested in the ADV-RESP frame; the method further includes:
determining, by the initiator, an MMS packet used for the MMS ranging is an MMS packet including a single fragment with a ranging marker;
setting, by the initiator, a thirteenth indication for requesting to reverse fragment interleaving in a last access slot in the MMS ranging in the SOR frame to be valid; and
transmitting, by the initiator, an MMS packet in the last access slot after receiving a first fragment of an MMS packet transmitted by an N-th responder.

In the scenario where the MMS packet used for the MMS ranging has a single fragment with RMARKER, reversing of fragment interleaving in a last access slot in the MMS ranging may be required to enable DS-TWR. In the case that the reversing of fragment interleaving in the last access slot in the MMS ranging is not requested in the ADV-RESP frame, the thirteenth indication in the SOR frame may be set to be valid, thus reversing of fragment interleaving in the last access slot in the MMS ranging may still be requested to enable DS-TWR.

In an embodiment form of the method according to the first aspect as such, the method further includes:
recording, by the initiator, a third transmission time of a first ranging marker of a first fragment of a first MMS packet from the initiator to an (N−1)-th responder, a second reception time of a second ranging marker of a first fragment of a second MMS packet from the N-th responder to the initiator, and a fourth transmission time of a third ranging marker of a first fragment of a third MMS packet from the initiator to the N-th responder; and
computing, by the initiator, the first round-trip time and the first reply time according to the third transmission time, the second reception time, and the fourth transmission time.

The DS-TWR for the N-th responder (last responder) can be enabled based on the reversing of fragment interleaving in the last access slot when an MMS packet used for the MMS ranging is an MMS packet including a single fragment with a ranging marker.

In an embodiment form of the method according to the first aspect as such, the method further includes:
recording, by the initiator, a fifth first transmission time of a first ranging marker of a first fragment of a first MMS packet from the initiator to an m-th responder, a third reception time of a second ranging marker of a first fragment of a second MMS packet from the m-th responder to the initiator, and a sixth transmission time of a third ranging marker of a first fragment of a third MMS packet from the initiator to an (m+1)-th responder, 1≤m<N; and
computing, by the initiator, the first round-trip time and the first reply time according to the fifth transmission time, the third reception time, and the sixth transmission time.

The DS-TWR for the m-th responder (non-last responder) can be enabled.

In an embodiment form of the method according to the first aspect as such, an MMS packet from the initiator is skipped in an access slots other than a first access slot and a last access slot in the MMS ranging, the method further includes:
transmitting, by the initiator, a final MMS packet in a last access slot in the MMS ranging.

The initiator will not transmit an MMS packet in each access slot in measurement cycles, thereby reducing the ranging time.

In an embodiment form of the method according to the first aspect as such, N is even; the method further includes:
determining, by the initiator, an MMS packet used for the MMS ranging is an MMS packet including a single fragment with a ranging marker; and
transmitting, by the initiator, the final MMS packet in the last access slot in the MMS ranging after receiving a first fragment of an MMS packet transmitted by an N-th responder.

Through reversing the order of the MMS packet exchange in the last access slot, an additional MMS packet from the initiator may be unnecessary, and DS-TWR can still be enabled.

In an embodiment form of the method according to the first aspect as such, the method further includes:
recording, by the initiator, a seventh transmission time of a first ranging marker of a first fragment of a first MMS packet from the initiator in a first access slot, a fourth reception time of a second ranging marker of a first fragment of a second MMS packet from the N-th responder to the initiator, and an eighth transmission time of a third ranging marker of a first fragment of a third MMS packet from the initiator in a last access slot; and
computing, by the initiator, the first round-trip time and the first reply time according to the seventh transmission time, the fourth reception time, and the eighth transmission time.

The DS-TWR can be enabled based on the reversing of the order of the final MMS packet exchange in the last access slot when an MMS packet used for the MMS ranging is an MMS packet including a single fragment with a ranging marker and when N is even.

In an embodiment form of the method according to the first aspect as such, the method further includes:
determining, by the initiator, an MMS packet used for the MMS ranging is an MMS packet comprising at least two fragments with a ranging marker;
recording, by the initiator, a ninth transmission time of a first ranging marker of a first fragment of a first MMS packet from the initiator to an n-th responder, a fifth reception time of a second ranging marker of a first fragment of a second MMS packet from the n-th responder to the initiator, and a tenth transmission time of a third ranging marker of a second fragment of the first MMS packet that carries a ranging marker, 1≤n≤N; and
computing, by the initiator, the first round-trip time and the first reply time according to the ninth transmission time, the fifth reception time, and the tenth transmission time.

The DS-TWR for all the responders can be enabled when an MMS packet used for the MMS ranging is an MMS packet including at least two fragments with a ranging marker.

According to a second aspect the present disclosure relates to a communication method, including:
transmitting, by a responder, an advertising-response (ADV-RESP) frame to an initiator, where the ADV-RESP frame indicates a number N of the responder to participate in multi-millisecond (MMS) ranging, N≥1; and
receiving, by the responder, a start of ranging (SOR) frame from the initiator, where the SOR frame is used to provide a time offset at which a first range-measurement cycle to start.

In an embodiment form of the method according to the second aspect as such, the ADV-RESP frame includes a first indication, and the first indication is used to indicate the number N.

In an embodiment form of the method according to the second aspect as such, the ADV-RESP frame comprises a second indication, and the second indication is used to indicate a number of a remaining ADV-RESP frame to be transmitted following the ADV-RESP frame, the number of the remaining ADV-RESP frame included in an i-th ADV-RESP frame is N−i, and 1≤i≤N.

In an embodiment form of the method according to the second aspect as such, the number N is indicated by a number of the ADV-RESP frame transmitted by the responder.

In an embodiment form of the method according to the second aspect as such, N≥2, the method further includes:
coordinating, by N responders, a predetermined order for transmitting N ADV-RESP frames; and
the transmitting, by the responder, the ADV-RESP frame to the initiator comprises:
sequentially transmitting, by the N responders, N ADV-RESP frames to the initiator according to the predetermined order.

In an embodiment form of the method according to the second aspect as such, the ADV-RESP frame includes a first indication and a second indication, the first indication is used to indicate the number N, and the second indication is used to indicate a number of a remaining ADV-RESP frame to be transmitted following the ADV-RESP frame, the number of the remaining ADV-RESP frame included in an i-th ADV-RESP frame is N−i, and 1≤i≤N.

In an embodiment form of the method according to the second aspect as such, N≥2, the ADV-RESP frame further includes a third indication, and the third indication is used to indicate N responders are synchronized with each other.

In an embodiment form of the method according to the second aspect as such, the transmitting, by the responder, the ADV-RESP frame to the initiator includes:
transmitting, by one responder, one ADV-RESP frame to the initiator, wherein the one responder is predetermined or dynamically selected from the responder to participate in the MMS ranging.

In an embodiment form of the method according to the second aspect as such, before the transmitting, by the responder, the ADV-RESP frame to the initiator, the method further includes:
receiving, by the responder, an advertising-poll (ADV-POLL) frame from the initiator, wherein the ADV-POLL frame is used to indicate a maximum number of K responder supported for the MMS ranging, and K≥1.

In an embodiment form of the method according to the second aspect as such, the receiving, by the responder, the SOR frame from the initiator includes:
receiving, by the responder, the SOR frame including a fourth indication indicating a number M of a responder for MMS ranging, M≤N.

In an embodiment form of the method according to the second aspect as such, the ADV-RESP frame further includes a fifth indication for indicating that a POLL frame is absent in a ranging control phase other than in a first access slot in the MMS ranging.

In an embodiment form of the method according to the second aspect as such, the ADV-RESP frame further includes a sixth indication for indicating that an RESP frame is absent in the ranging control phase other than in the first access slot.

In an embodiment form of the method according to the second aspect as such, the ADV-RESP frame further includes a fourteenth indication for indicating that the responder is requested to transmit a measurement report, the method further includes:
transmitting, by the responder, a report frame.

In an embodiment form of the method according to the second aspect as such, N≥2, and the ADV-RESP frame further includes an eighth indication for requesting a consolidated measurement report; the method further includes:
collecting, by the responder, measurement reports from N responders;
generating, by the responder, the consolidated measurement report according to the measurement reports from the N responders; and
transmitting, by the responder, the report frame includes:
transmitting, by the responder, the report frame carrying the consolidated measurement report.

In an embodiment form of the method according to the second aspect as such, the ADV-RESP frame further includes a ninth indication for requesting a double-sided two-way ranging (DS-TWR) measurement in a measurement report, and a fourteenth indication for indicating that the responder is requested to transmit a measurement report is included in the ADV-RESP frame; the method further includes:
transmitting, by the responder, the measurement report including both a second round-trip time and a second reply time field.

In an embodiment form of the method according to the second aspect as such, the ADV-RESP frame further includes a tenth indication for requesting the initiator to transmit an additional MMS packet; the method further includes:
receiving, by the responder, the additional MMS packet from the initiator.

In an embodiment form of the method according to the second aspect as such, an additional MMS packet is not requested in the ADV-RESP frame, and an eleventh indication for requesting the initiator to transmit an additional MMS packet in the SOR frame is set to be valid when an MMS packet used for the MMS ranging is an MMS packet comprising a single fragment with a ranging marker.

In an embodiment form of the method according to the second aspect as such, the method further includes:
recording, by an N-th responder, a sixth reception time of a first ranging marker of a first fragment of a first MMS packet from the initiator to the N-th responder, an eleventh transmission time of a second ranging marker of a first fragment of a second MMS packet from the N-th responder to the initiator, and a seventh reception time of a third ranging marker of a first fragment of the additional MMS packet; and
computing, by the N-th responder, the second round-trip time and the second reply time according to the sixth reception time, the eleventh transmission time, and the seventh reception time.

In an embodiment form of the method according to the second aspect as such, the ADV-RESP frame further includes a twelfth indication for requesting to reverse fragment interleaving in a last access slot in the MMS ranging; the method further includes:
transmitting, by an N-th responder, a first fragment of an MMS packet to the initiator; and
receiving, by the N-th responder, an MMS packet in a last access slot in the MMS ranging from the initiator.

In an embodiment form of the method according to the second aspect as such, reversing of fragment interleaving in a last access slot in the MMS ranging is not requested in the ADV-RESP frame; a thirteenth indication for requesting to reverse fragment interleaving in a last access slot in the MMS ranging in the SOR frame is set to be valid when an MMS packet used for the MMS ranging is an MMS packet including a single fragment with a ranging marker; the method further includes:
transmitting, by an N-th responder, a first fragment of an MMS packet to the initiator; and
receiving, by the N-th responder, an MMS packet in a last access slot in the MMS ranging from the initiator.

In an embodiment form of the method according to the second aspect as such, the method further includes:
recording, by the N-th responder, an eighth reception time of a first ranging marker of a first fragment of a first MMS packet from the initiator to an (N−1)-th responder, a twelfth transmission time of a second ranging marker of a first fragment of a second MMS packet from the N-th responder to the initiator, and a ninth reception time of a third ranging marker of a first fragment of a third MMS packet from the initiator to the N-th responder; and
computing, by the N-th responder, the second round-trip time and the second reply time according to the eighth reception time, the twelfth transmission time, and the ninth reception time.

In an embodiment form of the method according to the second aspect as such, the method further includes:
recording, by an m-th responder, a tenth reception time of a first ranging marker of a first fragment of a first MMS packet from the initiator to the m-th responder, a thirteenth transmission time of a second ranging marker of a first fragment of a second MMS packet from the m-th responder to the initiator, and an eleventh reception time of a third ranging marker of a first fragment of a third MMS packet from the initiator to an (m+1)-th responder, 1≤m<N; and
computing, by the m-th responder, the second round-trip time and the second reply time according to the tenth reception time, the thirteenth transmission time, and the eleventh reception time.

In an embodiment form of the method according to the second aspect as such, an MMS packet from the initiator is skipped in an access slots other than a first access slot and a last access slot in the MMS ranging, the method further includes:
receiving, by the responder, a final MMS packet in a last access slot in the MMS ranging.

In an embodiment form of the method according to the second aspect as such, N is even, and an MMS packet used for the MMS ranging is an MMS packet comprising a single fragment with a ranging marker; the method further includes:
transmitting, by an N-th responder, a first fragment of an MMS packet to the initiator; and
receiving, by the N-th responder, the final MMS packet in a last access slot in the MMS ranging from the initiator.

In an embodiment form of the method according to the second aspect as such, the method further includes:
recording, by the N-th responder, a twelfth reception time of a first ranging marker of a first fragment of a first MMS packet from the initiator in a first access slot, a fourteenth transmission time of a second ranging marker of a first fragment of a second MMS packet from the N-th responder to the initiator, and a thirteenth reception time of a third ranging marker of a first fragment of a third MMS packet from the initiator in a last access slot; and
computing, by the N-th responder, the second round-trip time and the second reply time according to the twelfth reception time, the fourteenth transmission time, and the thirteenth reception time.

In an embodiment form of the method according to the second aspect as such, an MMS packet used for the MMS ranging is an MMS packet including at least two fragments with a ranging marker; the method further includes:
recording, by an n-th responder, a fourteenth reception time of a first ranging marker of a first fragment of a first MMS packet from the initiator to the n-th responder, a fifteenth transmission time of a second ranging marker of a first fragment of a second MMS packet from the n-th responder to the initiator, and a fifteenth reception time of a third ranging marker of a second fragment of the first MMS packet that carries a ranging marker, 1≤n≤N; and
computing, by the n-th responder, the second round-trip time and the second reply time according to the fourteenth reception time, the fifteenth transmission time, and the fifteenth reception time.

According to a third aspect, the present disclosure relates to a communication apparatus including various units for performing the method according to the first aspect or embodiment in the first aspect.

According to a fourth aspect, the present disclosure relates to a communication apparatus including various units for performing the method according to the second aspect or embodiment in the second aspect.

According to a fifth aspect, the present disclosure relates to an electronic device including processing circuitry for performing the method according to the first aspect or embodiment in the first aspect.

According to a sixth aspect, the present disclosure relates to an electronic device including processing circuitry for performing the method according to the second aspect or embodiment in the second aspect.

According to a seventh aspect, the present disclosure relates to a chip including an input/output (I/O) interface and a processor, where the processor is configured to call and run a computer program stored in a memory, to enable a device installing with the chip to execute the method according to the first aspect or embodiment in the first aspect.

According to an eighth aspect, the present disclosure relates to a chip including an input/output (I/O) interface and a processor, where the processor is configured to call and run a computer program stored in a memory, to enable a device installing with the chip to execute the method according to the second aspect or embodiment in the second aspect.

According to a ninth aspect, the present disclosure relates to an electronic device, including one or more processors; and a non-transitory computer-readable storage medium coupled to the one or more processors and storing programming for execution by the processors, where the programming, when executed by the processors, configures the decoder to perform the method according to the first aspect or embodiment in the first aspect.

According to a tenth aspect, the present disclosure relates to an electronic device, including one or more processors; and a non-transitory computer-readable storage medium coupled to the one or more processors and storing programming for execution by the processors, where the programming, when executed by the processors, configures the encoder to perform the method according to the second aspect or embodiment in the second aspect.

According to an eleventh aspect, the present disclosure relates to a communication system, including the electronic device according to the ninth aspect and the electronic device according to the tenth aspect.

According to a twelfth aspect, the present disclosure relates to a non-transitory computer-readable medium carrying a program code which, when executed by a computer device, causes the computer device to perform the method according to the first aspect or embodiment in the first aspect.

According to a thirteenth aspect, the present disclosure relates to a non-transitory computer-readable medium carrying a program code which, when executed by a computer device, causes the computer device to perform the method according to the second aspect or embodiment in the second aspect.

According to a fourteenth aspect, the present disclosure relates to a computer program product comprising program code for performing the method according to the first aspect or embodiment in the first aspect.

According to a fifteenth aspect, the present disclosure relates to a computer program product comprising program code for performing the method according to the second aspect or embodiment in the second aspect.

The present disclosure provides communication methods and apparatuses, electronic devices, and related products. The initiator acquires the number of the responder to participate in MMS ranging through the ADV-RESP frame transmitted by the responder, and then transmits the SOR frame according to the number of the responder to participate in MMS ranging, thus, the initiator acquires the number of the responder to participate in MMS ranging once a responder transmits the ADV-RESP frame to the initiator, which is beneficial for normal operations of MMS ranging.

### BRIEF DESCRIPTION OF DRAWINGS

In the following, embodiments of the present disclosure are described in more detail with reference to the attached figures and drawings, in which:

FIG. 1 is a schematic diagram of a block-based mode of ranging.

FIG. 2 is a schematic diagram of UWB MMS ranging.

FIG. 3 is a schematic diagram of the operation of DS-TWR.

FIG. 4 is a schematic diagram of one-to-many SS-TWR ranging procedure using Narrow Band Assisted (NBA)-UWB MMS ranging.

FIG. 5 is a schematic diagram of a collision during the initialization and setup phase for one-to-many MMS ranging.

FIG. 6 is a schematic flowchart of a communication method according to an embodiment of the present disclosure.

FIG. 7 is a schematic diagram of a vehicle digital key application scenario according to an embodiment of the present disclosure.

FIG. 8 is a schematic diagram of one-to-many ranging according to an embodiment of the present disclosure

FIG. 9 is a schematic diagram of a message flow in one-to-many ranging according to an embodiment of the present disclosure.

FIG. 10 is a schematic diagram of an ADV-POLL frame according to an embodiment of the present disclosure.

FIG. 11 is a schematic diagram of an ADV-RESP frame according to an embodiment of the present disclosure.

FIG. 12 is a schematic diagram of an SOR frame according to an embodiment of the present disclosure.

FIG. 13 is a schematic diagram of an RIM frame according to an embodiment of the present disclosure.

FIG. 14 is a schematic diagram of an RPRT frame according to an embodiment of the present disclosure.

FIG. 15 is a schematic diagram of one-to-one MMS ranging adapted for DS-TWR according to an embodiment of the present disclosure.

FIG. 16 is a schematic diagram of a POLL frame according to an embodiment of the present disclosure.

FIG. 17 is a schematic diagram of one-to-many MMS ranging adapted for DS-TWR according to an embodiment of the present disclosure.

FIG. 18 is a schematic diagram of the UWB MMS packet exchange between the initiator and the last responder according to an embodiment of the present disclosure.

FIG. 19 is a schematic diagram of the UWB MMS packet exchange between the initiator and the responders according to an embodiment of the present disclosure.

FIG. 20 is a scenario schematic diagram of digital key for garage door according to an embodiment of the present disclosure.

FIG. 21 is a schematic diagram of one-to-many ranging according to another embodiment of the present disclosure.

FIG. 22 is a schematic diagram of one-to-many MMS ranging adapted for DS-TWR according to another embodiment of the present disclosure.

FIG. 23 is a schematic diagram of an ADV-RESP frame according to another embodiment of the present disclosure.

FIG. 24 is a schematic diagram of the UWB MMS packet exchange between the initiator and the last responder adapted for odd number of responders according to an embodiment of the present disclosure.

FIG. 25 is a schematic diagram of the UWB MMS packet exchange between the initiator and the last responder adapted for even number of responders according to an embodiment of the present disclosure.

FIG. 26 is a schematic diagram of yet another vehicle digital key application scenario according to an embodiment of the present disclosure.

FIG. 27 is a schematic diagram of one-to-many MMS ranging adapted for DS-TWR according to yet another embodiment of the present disclosure.

FIG. 28 is a schematic diagram of an ADV-RESP frame according to yet another embodiment of the present disclosure.

FIG. 29 is a schematic diagram of the UWB MMS packet exchange between the initiator and the responders according to another embodiment of the present disclosure.

FIG. 30 is a block diagram of a communication apparatus according to an embodiment of the present disclosure.

FIG. 31 is a block diagram of a communication apparatus according to another embodiment of the present disclosure.

FIG. 32 is a schematic structural diagram of an electronic device according to an embodiment of the present disclosure.

### DESCRIPTION OF EMBODIMENTS

In the following description, reference is made to the accompanying figures, which form part of the disclosure, and which show, by way of illustration, aspects of embodiments of the present disclosure or aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of method operations are described, a corresponding device may include one or a plurality of units, e.g. functional units, to perform the described one or plurality of method operations (e.g. one unit performing the one or plurality of operations, or a plurality of units each performing one or more of the plurality of operations), even if such one or more units are not explicitly described or illustrated in the figures. On the other hand, for example, if an apparatus is described based on one or a plurality of units, e.g. functional units, a corresponding method may include one operation to perform the functionality of the one or plurality of units (e.g. one operation performing the functionality of the one or plurality of units, or a plurality of operations each performing the functionality of one or more of the plurality of units), even if such one or plurality of operations are not explicitly described or illustrated in the figures. Further, it is understood that the features of the various exemplary embodiments and/or aspects described herein may be combined with each other, unless noted otherwise.

Ultra-wideband (UWB) technology is increasingly being used for indoor positioning and other location services such as access control and asset locating. Aside from dedicated devices and tags, UWB radios are becoming increasingly common in high end smartphones. The UWB physical layers (PHYs) and media access control (MAC) are standardized by the IEEE and the most recent related IEEE publication are the IEEE 802.15.4-2020 and the IEEE 802.15.4z. Recently a new task group, 802.15.4ab is actively working on enhancements to the UWB technology.

Aside from the traditional ranging use case, other use cases, such as device free sensing, Downlink time difference of arrival (DL-TDOA), long-range ranging, etc., are being actively investigated. To address the long-range ranging use case, Multi-millisecond (MMS) ranging has been introduced in 802.15.4ab (see 15-21-0409-01-04ab-narrowband-assisted-multi-millisecond-uwb). The key idea behind MMS ranging is to distribute UWB ranging frames into multiple fragments being transmitted across multiple milliseconds (ms), thereby overcoming the emitted energy limit of 37 nJ per ms. The MMS ranging may be further enhanced by a high-performance narrowband (NB) radio which is used to provide time synchronization for the UWB radio and is also used for control signaling. This is termed as NBA-UWB MMS ranging. In MMS ranging, the number of fragments required for the ranging depends on the range to be measured as well as channel conditions, and hence may be dynamically adjusted even within the same ranging session.

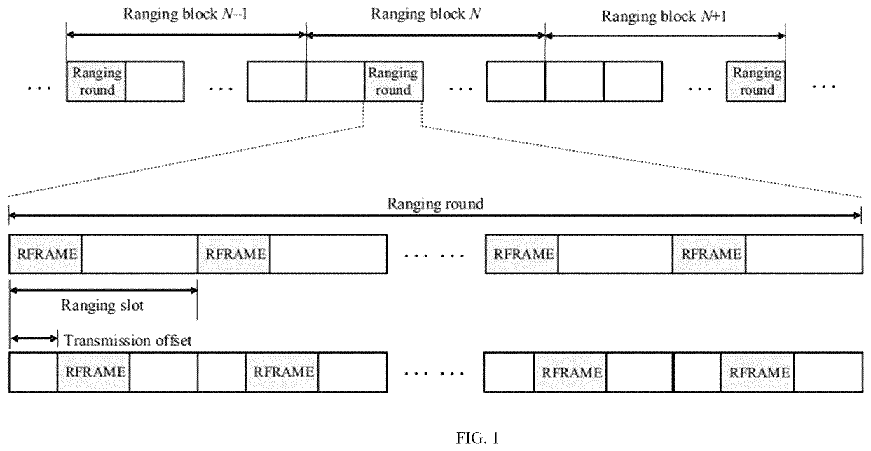

Ranging technology, for example a block-based mode of ranging, may be used in various scenarios, such as tags, smartphones, laptops, key fobs, vehicles, door locks, garages, hotel rooms, elevators, etc. The block-based time structure is defined in 802.15.4z for the block-based mode of ranging and is illustrated in FIG. 1. Each ranging block consists of a whole number of ranging rounds, where a ranging round is a period of sufficient duration to complete one entire range-measurement cycle involving a set of enhanced ranging capable devices (ERDEVs) participating in the ranging exchange. Each ranging round is further subdivided into an integer number of ranging slots where a ranging slot is a time period of sufficient duration for the transmission of at least one ranging frame (RFRAME). The block-based mode uses a structured timeline where the ranging block structure is periodic by default.

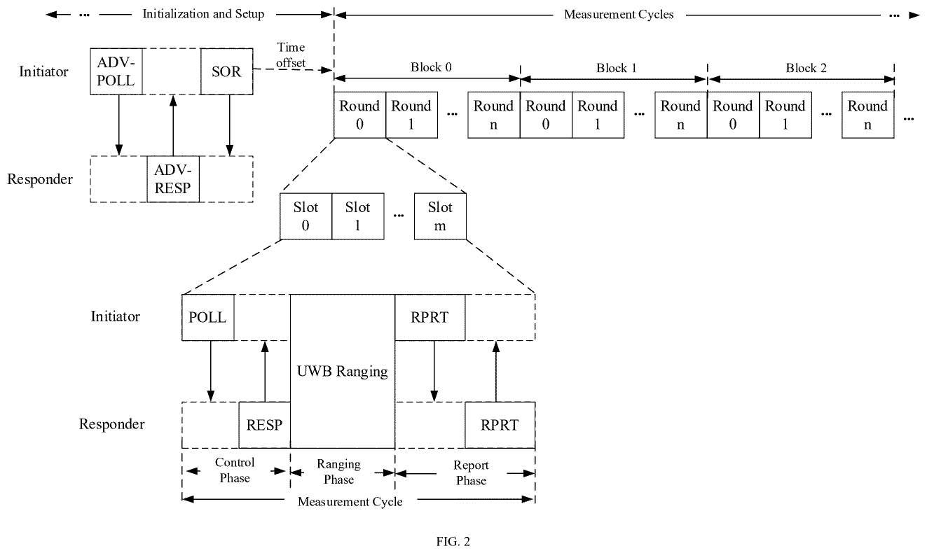

The Ultra-wideband (UWB) Multi-millisecond (MMS) ranging being discussed in IEEE 802.15.4ab is illustrated in FIG. 2. An MMS ranging session may include an initialization and setup phase followed by one or more measurement cycles. During the initialization and setup phase, frames are transmitted in an initialization channel, while during the measurement cycles, the frames are transmitted in a ranging channel. While the same channel may be used as both the initialization channel and the ranging channel, it is more likely that one or more well-known channels will be used as the initialization channel.

In the initialization and setup phase, initiators and responders may negotiate ranging configuration which is different from the default configuration defined by 802.15.4ab. An Initiator transmits advertising poll (ADV-POLL) frames opportunistically at times and intervals to its discretion while responder(s) may opportunistically listen for incoming ADV-POLL frames and respond with an advertising response (ADV-RESP) frame if the responder intends to participate in a ranging session with the initiator. Once the initiator has received an ADV-RESP packet, it transmits a start of ranging (SOR) packet that provides a time offset at which a first range-measurement cycle will start.

A range-measurement cycle includes a ranging control phase, a ranging phase and may include a measurement reporting phase. The ranging control phase starts at the beginning of the range-measurement cycle. An initiator starts the ranging control phase by transmitting a POLL frame to a responder at the beginning of a first ranging slot of a ranging round. A responder that receives the POLL frame successfully transmits a RESP frame back to the initiator. The POLL and RESP frames allow the initiator and the responder to achieve time and frequency synchronization. The initiator may also include other control information in the POLL frame for the responder. In the ranging phase, the initiator and the responder may exchange zero or more MMS UWB packets. An MMS UWB packet consists of multiple fragments and may include zero or more ranging sequence fragments (RSFs) and one or more ranging integrity fragments (RIFs). The RSFs are used to perform ranging measurements while the RIFs are used to check the integrity of the ranging measurements. An MMS UWB packet could be either an RSF-only MMS UWB packet, RIF-only MMS UWB packet, or a mixed MMS UWB packet. In a mixed MMS UWB packet format for ranging integrity, RIFs may follow RSFs. A RIF-only MMS UWB packet only includes RIFs. After the initiator or the responder, completes the reception of all UWB fragments for the ranging phase, the report phase starts in which the initiator and/or the responder generate a ranging measurement report, and send a RPRT frame carrying the ranging measurement report to the peer device. The timestamp that is reported is measured relative to a ranging marker (RMARKER). For all legacy physical layers (PHYs) the RMARKER is defined to be the time when the beginning of the first symbol following the start-of-frame delimiter (SFD) of the RFRAME is at the local antenna. For MMS UWB packets, the RMARKER for the RSF and the RIF are called RSF-RMARKER and RIF-RMARKER respectively. For RSF-only MMS packets or for mixed MMS packets, the RSF-RMARKER is defined as the peak of the first pulse in the first RSF. For RIF-only MMS packets or for mixed MMS packets, each RIF consists of two RIF-MARKERs, which are defined as the peak of the first pulse and the peak of the last pulse respectively in each RIF. When an RIF is used for SS-TWR or DS-TWR timing measurements, the first RIF-RMARKER of the RIF is used as the RMARKER for the timing measurements.

MMS ranging comes in two flavors: 1) UWB only MMS ranging in which the control frames as well as the ranging fragments are transmitted using UWB; and 2) Narrowband assisted UWB multi-millisecond (NBA-UWB MMS) ranging, in which the ranging fragments are transmitted using UWB while the control frames are transmitted using narrow band, for example, using the O-QPSK PHY specified in IEEE 802.15.4-2020.

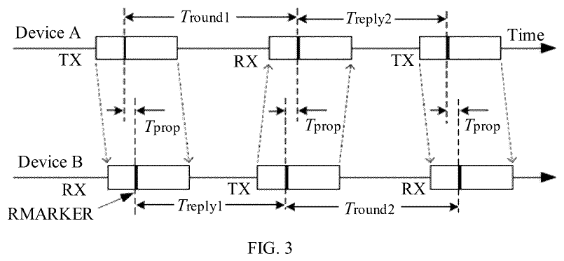

Several ranging and localization methods are described in IEEE 802.15.4z. Single-sided two-way ranging (SS-TWR) involves a measurement of the round-trip delay of a single message from one device to another and a response sent back to the original device. Double-sided two-way ranging (DS-TWR) is an extension of SS-TWR in which two round-trip time measurements are used and combined to give the time of flight (TOF) result with a reduced error in the presence of uncorrected clock frequency offset even for quite long response delays. The operation of DS-TWR is shown in FIG. 3, where device A initiates the first round-trip time measurement to which device B responds, after which device B initiates the second round-trip time measurement to which device A responds completing the full DS-TWR exchange, and Tₚᵣₒₚ is the propagation time of the RMARKER between the devices.

Each device precisely measures the transmission and reception times of the messages, and the resultant TOF may be estimated as \hat{T}ₚᵣₒₚ by the following equation:

$${\hat{T}}_{prop} = \frac{( {T}_{round 1} \times {T}_{round 2} - {T}_{reply 1} \times {T}_{reply 2} )}{( {T}_{round 1} + {T}_{round 2} + {T}_{reply 1} + {T}_{reply 2} )} \qquad Equation 1$$

where T_{round} is the round-trip time, and T_{reply} is the reply time.

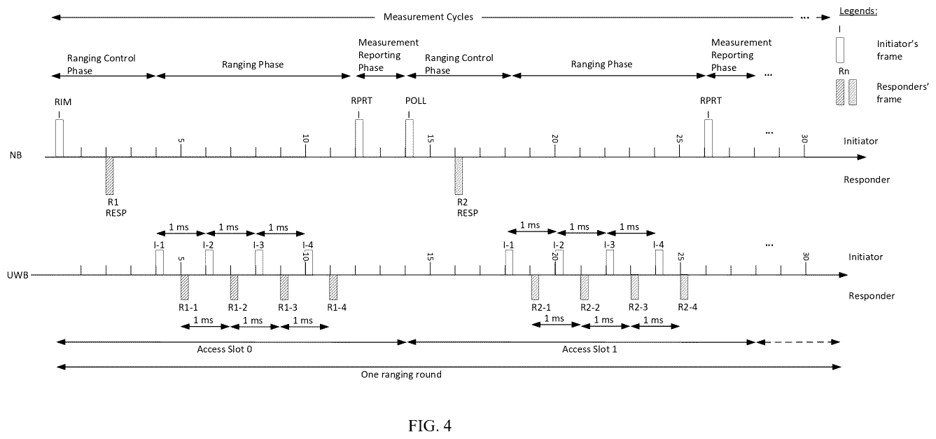

The UWB MMS ranging being discussed in IEEE 802.15.4ab (see IEEE 802.15-22/0381r2) is illustrated in FIG. 2 described above. One-to-many SS-TWR ranging procedure using MMS ranging is also being discussed in IEEE 802.15.4ab (see IEEE 802.15-22/00151r2). There are two types depending on whether Narrow Band Assisted method (NBA-UWB) is used. When NBA-UWB is not used, all frames are transmitted on the UWB band. When NBA-UWB is used, the control frames are transmitted on the NB channel while the MMS ranging frames are transmitted on the UWB band. One-to-many SS-TWR ranging procedure using NBA-UWB MMS ranging is illustrated in FIG. 4. The frames exchanged using the NB radio and the UWB radio are illustrated under two different lines; where the frames transmitted by the initiator being on top of the line while the frame transmitted by the responder(s) being below the line. The initiator starts the ranging exchange by transmitting a broadcast ranging initiation message (RIM). The RIM may include the configuration parameters for the one-to-many ranging round which divide the ranging slots in the ranging round into multiple access slots, with one responder assigned to one access slot. In each access slot, the ranging control, ranging, measurement reporting phases are the same as the one-to-one MMS described above. Particularly, in access slot 0, the ranging initiation message also serves the time synchronization function as a Poll message. In the example shown in FIG. 4, each responder sends the measurement report back to the initiator in its assigned access slot and the initiator computes the range based on the measurement report.

The initialization and setup phase of the UWB MMS ranging described above and illustrated in FIG. 2 only considers the one-to-one MMS ranging and may not be suitable for one-to-many MMS ranging. During the initialization and setup phase for one-to-many MMS ranging, multiple responders may receive the ADV-POLL frame transmitted by the initiator, and multiple responders may transmit ADV-RESP frames at the same time in response, causing the ADV-RESP frames to collide at the initiator, leading to the initiator not being able to receive any of the ADV-RESP frames. Even if the responders were to use mechanisms such as listen before talk (LBT) and manage to transmit the ADV-RESP frames successfully, an SOR frame transmitted by the initiator in response to the ADV-RESP frame may still collide with the delayed ADV-RESP frames from some responders. This is illustrated in FIG. 5.

As for the one-to-many SS-TWR ranging procedure using NBA-UWB MMS ranging illustrated in FIG. 4, T_{round} (round-trip time) and T_{reply} (reply time) are measured independently by the initiator and the responders using their local clocks, which both have some clock frequency offset errors, from their nominal frequency, resulting in the TOF estimate having considerable error that increases as the reply times get larger. In fact, this issue is also present in one-to-one MMS ranging.

The present disclosure aims at solving the above problems. Solutions are proposed to enhance the initialization and setup phase of the UWB MMS ranging, and also to enhance the ranging and reporting phases of the UWB MMS ranging (one-to-one or one-to-many) to enable DS-TWR.

The present disclosure is applicable in any application scenario that uses the UWB MMS ranging.

Before describing the solutions in the present disclosure, relevant nomenclature will be introduced as follows.

Controller: a device that controls a UWB session and defines session parameters.

Controlee: a device that utilizes the session parameters received from the controller to participate in the UWB session.

Initiator: a device that follows the instruction from the controller, and initiates a UWB exchange by sending a first message of the exchange. A controller or a controlee can be an initiator.

Responder: a device that responds to the first message received from the initiator and participates in the UWB exchange. A controller or a controlee can be a responder.

NB-UWB module: a module including a UWB radio and a NB radio that are tightly coupled (e.g., housed in the same hardware component).

Synchronized one-to-many ranging: one-to-many ranging where all the responders are connected to each other and are able to coordinate their actions.

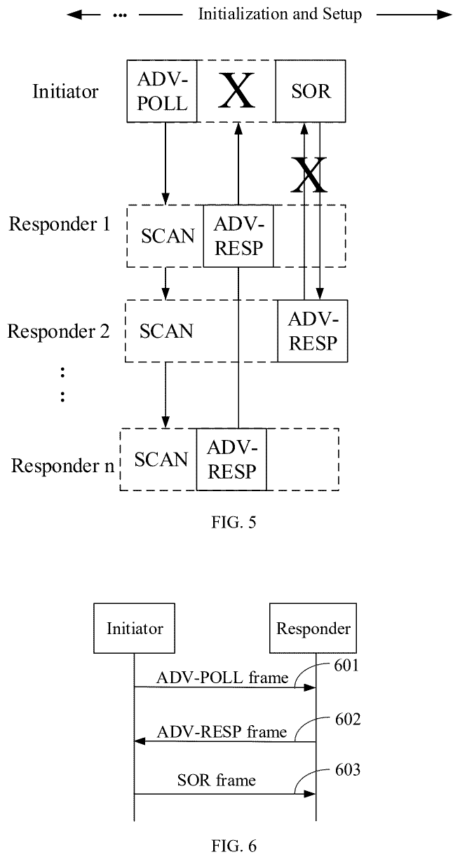

The embodiments of the present disclosure will be elaborated with reference to accompanying figures. The present disclosure provides a communication method involving the interaction between an initiator and a responder. Reference may be made to FIG. 6, the communication method may include the following operations.

Operation 601, an initiator transmits an ADV-POLL frame to a responder.

The ADV-POLL frame may be used to indicate a maximum number of K responder supported for MMS ranging, and K≥1. The structure of the ADV-POLL frame will be described later. The maximum number may be specified by the Maximum Responders field in the ADV-POLL frame. The maximum number of K responder supported for the MMS ranging may indicate that whether the initiator supports one-to-many MMS ranging or not. When K is a value larger than one, it means that initiator supports one-to-many MMS ranging.

Operation 602, the responder transmits an ADV-RESP frame to the initiator.

The ADV-RESP frame indicates a number N of a responder to participate in MMS ranging, and N≥1. The structure of the ADV-RESP frame will be described later.

The number N may be indicated in an explicit manner, for example, in an embodiment, the ADV-RESP frame includes a first indication, and the first indication is used to indicate the number N; in another embodiment, the ADV-RESP frame includes a second indication, and the second indication is used to indicate a number of a remaining ADV-RESP frame to be transmitted following the ADV-RESP frame, the number of the remaining ADV-RESP frame included in an i-th ADV-RESP frame is N−i, and 1≤i≤N. The number N may be directly indicated by the first indication in the ADV-RESP frame, thereby saving signaling overhead; and may also be indirectly indicated by the second indication in the ADV-RESP frame, where the second indication indicates that the number of the remaining ADV-RESP frame included in an i-th ADV-RESP frame is N−i. In the case that N−i and i are given, the number N may be indirectly acquired. In addition, since the initiator has the knowledge of the number of the remaining ADV-RESP frame, the accuracy of the transmission time of the SOR frame can be improved even when the frame drop occurs. The first indication may be the Number of Responders field in the ADV-RESP frame, and the second indication may be the Remaining ADV-RESPs field in the ADV-RESP frame. It should be noted that, the first indication and the second indication may also be a same field in the ADV-RESP frame, and in this case, an additional field should be included in the ADV-RESP frame to indicate which indication is used.

The number N may also be indicated in an implicit manner, for example, in an embodiment, the number N is indicated by a number of the ADV-RESP frame received by the initiator, i.e., a number of the ADV-RESP frame transmitted by the responder, thereby saving signaling overhead.

In an embodiment, where N≥2, N responders may coordinate a predetermined order for transmitting N ADV-RESP frames, and N responders sequentially transmit N ADV-RESP frames to the initiator according to the predetermined order. The ADV-RESP frames are transmitted one after another in a coordinated fashion, ensuring that the ADV-RESP frames do not collide with each other. When the initiator receives the ADV-RESP frame indicating N responders to participate in MMS ranging, it is alerted that N responders will transmit the ADV-RESP frames and thus refrains from transmitting the SOR frame. Thus, the collision of the ADV-RESP frames with each other or with the SOR frame is prevented.

In an embodiment, the ADV-RESP frame further includes a fifth indication for indicating that a POLL frame is absent in a ranging control phase other than in a first access slot in the MMS ranging. The fifth indication may be the POLL Absent In Control Phases field in the ADV-RESP frame. The POLL frame is absent in a ranging control phase other than in a first access slot in the MMS ranging, thus one measurement cycle can be completed with less time, and shorter ranging duration can be achieved.

In an embodiment, the ADV-RESP frame further includes a sixth indication for indicating that an RESP frame is absent in the ranging control phase other than in the first access slot. The sixth indication may be the RESP Absent In Control Phases field in the ADV-RESP frame. The RESP frame is absent in the ranging control phase other than in the first access slot in the MMS ranging, thus one measurement cycle can be completed with less time, and shorter ranging duration can be achieved.

The ADV-RESP frame further includes a field for requesting to transmit a measurement report, the responder or the initiator may be requested to transmit the measurement report according to actual needs. In addition, when the consolidated measurement report is requested, the Measurement Report Phase is not included in the access slots and the initiator reserves slots at the end of the ranging round to transmit consolidated measurement reports from/for all responders, that is, it is unnecessary to transmit a measurement report in each access slot, thereby reducing the ranging time, and shorter ranging duration can be achieved.

In an embodiment, the ADV-RESP frame further includes a seventh indication for indicating that the initiator is requested to transmit a measurement report, the method further includes: the initiator transmits a report frame. The seventh indication may be the Initiator Report Requested field in the ADV-RESP frame.

In an embodiment, N≥2, and the ADV-RESP frame further includes an eighth indication for requesting a consolidated measurement report; the method further includes: the initiator generates the consolidated measurement report according to measurements for N responders, and transmits the report frame carrying the consolidated measurement report. The eighth indication may be the Consolidated Measurement Report field in the RPRT frame.

In an embodiment, the ADV-RESP frame further includes a fourteenth indication for indicating that the responder is requested to transmit a measurement report, the method further includes: the responder transmits a report frame. The fourteenth indication may be the Responder Report Requested field in the ADV-RESP frame.

In an embodiment, N≥2, and the ADV-RESP frame further includes an eighth indication for requesting a consolidated measurement report; the method further includes: the responder collects measurement reports from N responders, generates the consolidated measurement report according to the measurement reports from the N responders, and transmits the report frame carrying the consolidated measurement report. The eighth indication may be the Consolidated Measurement Report field in the RPRT frame.

Next, embodiments of DS-TWR will be introduced, both the round-trip time and the reply time are measured by the initiator or the responder, thereby curing the defects of SS-TWR as described above. The embodiments of DS-TWR provided by the present disclosure can be applied to one-to-one or one-to-many MMS ranging.

In an embodiment, the ADV-RESP frame further includes a ninth indication for requesting a double-sided two-way ranging (DS-TWR) measurement in a measurement report, and a seventh indication for indicating that the initiator is requested to transmit a measurement report is included in the ADV-RESP frame; the method further includes: the initiator transmits the measurement report including both a first round-trip time and a first reply time. The ninth indication may be the DS-TWR field in the ADV-RESP frame, and the seventh indication may be the Initiator Report Requested field in the ADV-RESP frame. For example, if the DS-TWR field is set to 1, it means that DS-TWR is enabled.

In an embodiment, the ADV-RESP frame further includes a tenth indication for requesting the initiator to transmit an additional MMS packet (which may also be referred to as an extra MMS packet); the method further includes: the initiator transmits the additional MMS packet. The tenth indication may be the Final MMS Packet Requested field in the ADV-RESP frame. For example, if the Final MMS Packet Requested field is set to 1, it means that the initiator is requested to transmit an additional MMS packet.

In an embodiment, an additional MMS packet is not requested in the ADV-RESP frame; the method further includes: the initiator determines that an MMS packet used for the MMS ranging is an MMS packet including a single fragment with a ranging marker, sets an eleventh indication for requesting the initiator to transmit an additional MMS packet in the SOR frame to be valid, and transmits the additional MMS packet. The eleventh indication may be the Final MMS Packet Requested field in the SOR frame. An MMS packet including a single fragment with a ranging marker may be an RIF-only MMS packet with a single fragment or an RSF-only MMS packet. In the scenario where the MMS packet used for the MMS ranging has a single fragment with RMARKER, an additional MMS packet from the initiator may be required to enable DS-TWR. In the case that an additional MMS packet is not requested in the ADV-RESP frame, for example, the Final MMS Packet Requested field is set to 0 in the ADV-RESP frame, the Final MMS Packet Requested field in the SOR frame may be set to 1, thus an additional MMS packet from the initiator may still be requested to enable DS-TWR. That is, the initiator may determine to transmit the additional MMS packet according to the type of the MMS packet even when the additional MMS packet is not requested by the responder.

The following will introduce the acquiring process of the first round-trip time and the first reply time in initiator's measurement report, the second round-trip time and the second reply time in responder's measurement report. The first round-trip time, the first reply time, the second round-trip time and the second reply time are used to estimate TOF as described in Equation 1, and hence estimate the range of the peer device.

When an MMS packet used for the MMS ranging is an MMS packet including a single fragment with a ranging marker, for example, an RIF-only MMS packet with a single fragment or an RSF-only MMS packet. For a last access slot, in an embodiment, the initiator records a first transmission time of a first ranging marker of a first fragment of a first MMS packet from the initiator to an N-th responder, a first reception time of a second ranging marker of a first fragment of a second MMS packet from the N-th responder m to the initiator, and a second transmission time of a third ranging marker of a first fragment of the additional MMS packet; and computes the first round-trip time and the first reply time according to the first transmission time, the first reception time, and the second transmission time. In an embodiment, an N-th responder records a sixth reception time of a first ranging marker of a first fragment of a first MMS packet from the initiator to the N-th responder, an eleventh transmission time of a second ranging marker of a first fragment of a second MMS packet from the N-th responder to the initiator, and a seventh reception time of a third ranging marker of a first fragment of the additional MMS packet; and computes the second round-trip time and the second reply time according to the sixth reception time, the eleventh transmission time, and the seventh reception time. The DS-TWR for the N-th responder (last responder) can be enabled based on the additional MMS packet when an MMS packet used for the MMS ranging is an MMS packet including a single fragment with a ranging marker.

For a non-last access slot, in an embodiment, the initiator records a fifth transmission time of a first ranging marker of a first fragment of a first MMS packet from the initiator to an m-th responder, a third reception time of a second ranging marker of a first fragment of a second MMS packet from the m-th responder to the initiator, and a sixth transmission time of a third ranging marker of a first fragment of a third MMS packet from the initiator to an (m+1)-th responder, 1≤m<N; and computes the first round-trip time and the first reply time according to the fifth transmission time, the third reception time, and the sixth transmission time. In an embodiment, an m-th responder records a tenth reception time of a first ranging marker of a first fragment of a first MMS packet from the initiator to an m-th responder, a thirteenth transmission time of a second ranging marker of a first fragment of a second MMS packet from the m-th responder to the initiator, and an eleventh reception time of a third ranging marker of a first fragment of a third MMS packet from the initiator to an (m+1)-th responder, 1≤m<N; and computes the second round-trip time and the second reply time according to the tenth transmission time, the thirteenth reception time, and the eleventh transmission time. Thus, the DS-TWR for the m-th responder (non-last responder) can be enabled.

When an MMS packet used for the MMS ranging is an MMS packet including at least two fragments with a ranging marker, for example, a mixed MMS packet or an RIF-only MMS packet with at least two fragments are used for MMS ranging, a single MMS packet exchange is enough for DS-TWR. For the acquiring process of the first round-trip time and the first reply time in this case, in an embodiment, the initiator determines that an MMS packet used for the MMS ranging is an MMS packet including at least two fragments with a ranging marker; records a ninth transmission time of a first ranging marker of a first fragment of a first MMS packet from the initiator to an n-th responder, a fifth reception time of a second ranging marker of a first fragment of a second MMS packet from the n-th responder to the initiator, and a tenth transmission time of a third ranging marker of a second fragment of the first MMS packet that carries a ranging marker, 1≤n≤N; and computes the first round-trip time and the first reply time according to the ninth transmission time, the fifth reception time, and the tenth transmission time.

For the acquiring process of the second round-trip time and the second reply time in the above case, in an embodiment, an n-th responder records a fourteenth reception time of a first ranging marker of a first fragment of a first MMS packet from the initiator to the n-th responder, a fifteenth transmission time of a second ranging marker of a first fragment of a second MMS packet from the n-th responder to the initiator, and a fifteenth reception time of a third ranging marker of a second fragment of the first MMS packet that carries a ranging marker, 1≤n≤N; and computes the second round-trip time and the second reply time according to the fifteenth reception time, the fifteenth transmission time, and the fifteenth reception time. Thus, the DS-TWR for all the responders can be enabled when an MMS packet used for the MMS ranging is an MMS packet including at least two fragments with a ranging marker.

Operation 603, the initiator transmits a start of ranging (SOR) frame to the responder according to the ADV-RESP frame.

The SOR frame is used to provide a time offset at which a first range-measurement cycle to start, and the structure of the SOR frame will be described later.

In an embodiment, the initiator transmits the SOR frame to the responder upon receiving an N-th ADV-RESP frame. Upon receiving the N-th ADV-RESP frame, that is, the last ADV-RESP frame (that indicates zero remaining ADV-RESP frames), the initiator transmits the SOR frame that indicates when the MMS ranging will start. Thus, the collision of the ADV-RESP frames with each other or with the SOR frame is prevented.

In another embodiment, the initiator estimates an expected transmission time of N ADV-RESP frame, and transmits the SOR frame to the responder upon elapse of the expected transmission time. In case the last ADV-RESP frame is not received by the initiator, once the expected total transmission time for all ADV-RESP frames has elapsed, the initiator transmits the SOR frame. Thus, the collision of the ADV-RESP frames with each other or with the SOR frame is prevented.

In an embodiment, before the initiator transmits the SOR frame to the responder, the initiator determines a number M of a responder for MMS ranging according to a number of received ADV-RESP frame, M≤N, and transmits the SOR frame including a fourth indication indicating the number M. That is, before the start of the MMS ranging, the initiator may select the responder for MMS ranging within the responders that transmit ADV-RESP frames to the initiator.

In the communication method provided by the present disclosure, the initiator acquires the number of the responder to participate in MMS ranging through the ADV-RESP frame transmitted by the responder, and then transmits the SOR frame according to the number of the responder to participate in MMS ranging, thus, the initiator acquires the number of the responder to participate in MMS ranging once a responder transmits the ADV-RESP frame to the initiator, which is beneficial for normal operations of MMS ranging. Since N responders are connected with each other and are able to communicate with each other, upon receiving the ADV-POLL frame, the N responders can coordinate their responses and transmit the ADV-RESP frames one after another in a coordinated fashion, ensuring that their ADV-RESP frames do not collide with each other. In addition, when the initiator receives the ADV-RESP frame indicating the N responders to participate in MMS ranging, it is alerted that N responders will transmit the ADV-RESP frames and thus refrains from transmitting the SOR frame. Thus, the collision of the ADV-RESP frames with each other or with the SOR frame is prevented. Further, DS-TWR can be enabled through setting the Final MMS Packet Requested field to be valid.

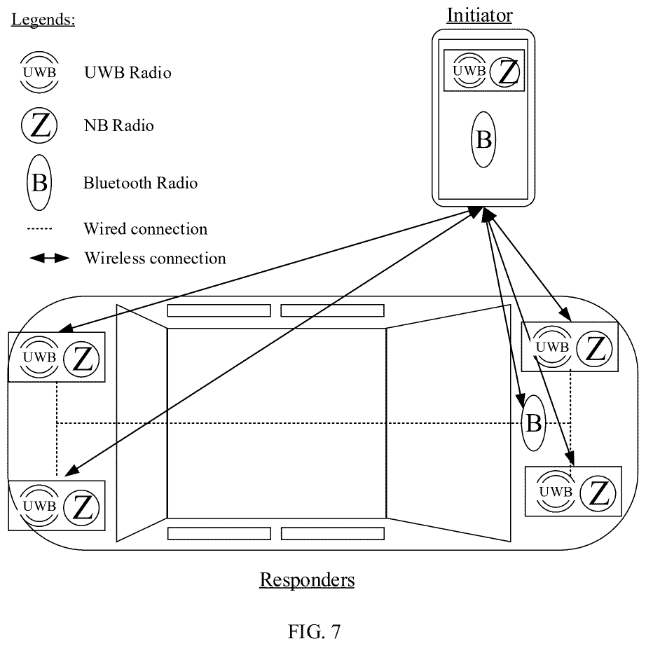

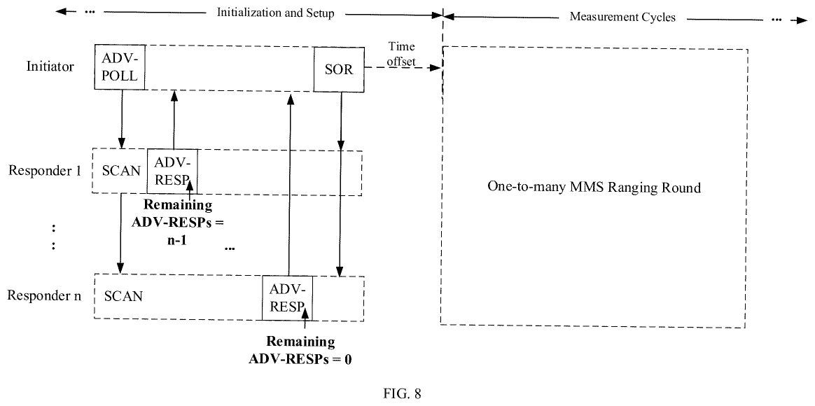

A vehicle digital key application scenario illustrated in FIG. 7 is taken as example 1, and there may be other scenarios, which is not limited herein. These days many mobile devices (e.g., smart phones) and vehicles support a digital key that can be used to lock and unlock an authorized vehicle (e.g., car), start/stop its engine or even share the digital key with friends and family to access the vehicle. Many such modern mobile devices and vehicles also support UWB radios that allow a vehicle to accurately determine a mobile device's location and even direction. When combined with the digital key, this enables digital key applications that allow locking/unlocking car doors even when a user holding the mobile device is still several meters away from the car. As explained earlier, in order to address the long-range ranging use case, MMS ranging has been introduced in 802.15.4ab which may be further enhanced by a high-performance narrowband (NB) radio which is used to provide time synchronization for the UWB radio and is also used for control signaling. The UWB radio and the NB radio may also be housed in the same hardware component forming a NB-UWB module. Several such NB-UWB modules may be installed in various locations in a vehicle (e.g., a car) to act as responders. One or more Bluetooth radios may also be installed. All these radios are also connected to each other, for example, using in-vehicle wired networks and are able to communicate with each other. There may be a central device in the vehicle that can control and coordinate all the radios. A compatible mobile device (e.g., smartphone) supports one each of the UWB, NB and Bluetooth radio and acts as the initiator for MMS ranging. The Bluetooth radio is used for an initial discovery, connection setup and credential validations, while the NB and UWB radios are used for the MMS ranging.

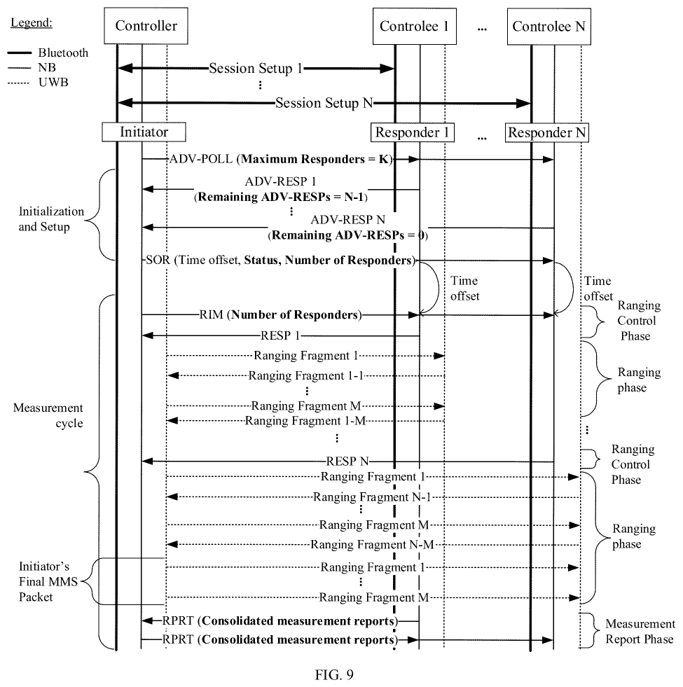

In the initialization and setup phase of MMS ranging, an initiator transmits advertising poll (ADV-POLL) frames opportunistically at times and intervals to its discretion while responder(s) may opportunistically listen for incoming ADV-POLL frames and respond with an advertising response (ADV-RESP) frame if the responder intends to participate in a ranging session with the initiator. Once the initiator has received an ADV-RESP packet, it transmits a start of ranging (SOR) packet that provides the time offset at which a first range-measurement cycle will start. However, if multiple responders receive the ADV-POLL frame transmitted by the initiator, multiple responders may transmit ADV-RESP frames at the same time in response causing the ADV-RESP frames to collide at the initiator, leading to the initiator not being able to receive any of the ADV-RESP frames. Even if the responders were to use mechanisms such as listen before talk (LBT) and manage to transmit the ADV-RESP frames successfully, the SOR frame transmitted by the initiator in response to the ADV-RESP frame may still collide with the delayed ADV-RESP frames from some responders as illustrated in FIG. 5. However, in applications in which the multiple responders are connected with each other and are able to communicate with each other, upon receiving the ADV-POLL frame, the responders can coordinate their responses and transmit the ADV-RESP frames, one after another in a coordinated fashion, ensuring that their ADV-RESP frames do not collide with each other, as illustrated in FIG. 8. Each ADV-RESP frame also indicates the number of remaining ADV-RESP frames that will be transmitted following the frame, depending on the number of responders that intend to participate in the MMS ranging.

When the initiator receives an ADV-RESP frame that indicates that one or more ADV-RESP frames are remaining, it is alerted that more responders will be transmitting ADV-RESP frames and thus refrains from transmitting the SOR frame. The initiator can also estimate the expected total transmission time for all ADV-RESP frames upon receiving an ADV-RESP frame that indicate the number of remaining ADV-RESP frames. Upon receiving the last ADV-RESP frame (that indicates zero remaining ADV-RESP frame), the initiator transmits the SOR frame that indicates when the MMS ranging will start. In case the last ADV-RESP frame is not received by the initiator, once the expected total transmission time for all ADV-RESP frames has elapsed, the initiator transmits the SOR frame. Thus, the collision of the ADV-RESP frames with each other or with the SOR frame is prevented.

An example message flow involved in a one-to-many UWB MMS ranging application with multiple coordinated responders that are adapted for DS-TWR is illustrated in FIG. 9. The MMS UWB ranging session begins with a controller and controlees performing a session setup during which long-term session parameters, such as the UWB channel number, preamble codes, block structure (the number of blocks, block durations) etc., are negotiated. In the vehicle digital key application, the mobile device (e.g., smartphone) acts as the controller, while the NB-UWB modules in the vehicle act as the controlees. When security is enabled, one or more security keys are also exchanged between the controller and controlees. For NBA-UWB MMS ranging, parameters related to narrow band (such as NB channel number, the number of MMS fragments etc.) may also be negotiated during the session setup. Additionally, the initiator and responder roles are also assigned during the session setup. The long-term parameters are not expected to change during a session. FIG. 9 illustrates the controller assuming the role of initiator while the controlees are assigned the role of responder, however in a different application, the controlee may be assigned the role of initiator while the controller assumes the role of responder. In contrast, parameters related to a measurement cycle, such as round/slot durations, number of MMS fragments, report mode etc., may be considered as short-term parameters and may be modified during a session. The session setup may be performed out-of-band, for example using Bluetooth or Wi-Fi radio, or may also be performed in-band, for example using narrow band or UWB radio.

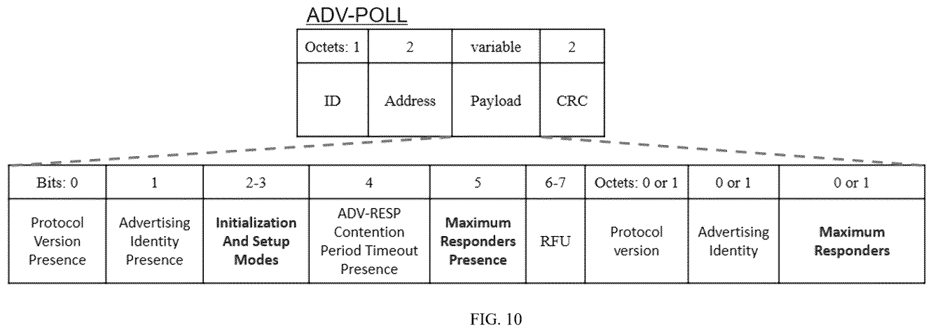

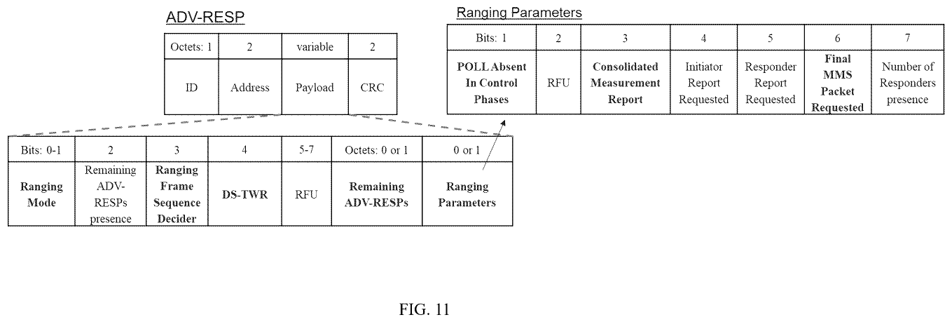

Once the session has been setup, the initiator transmits the ADV-POLL frame opportunistically at times and intervals to its discretion while responder(s) may opportunistically listen for incoming ADV-POLL frame and respond with the ADV-RESP frame if the responder intends to participate in a ranging session with the initiator. The ADV-POLL frame is illustrated in FIG. 10, and some key fields in the ADV-POLL frame will be introduced thereunder. It should be noted that, the ID field in each frame can be used to identify the type of the frame.

The Initialization And Setup Modes field indicates the allowed initialization and setup modes for the MMS ranging and may be set to one of the following values:
0=Single Responder: Only one-to-one ranging is supported
1=Contention based multiple Responders: Contention based one-to-many ranging is supported
2=Synchronized multiple Responders: Synchronized one-to-many ranging is supported
3=Reserved.

The Maximum Responders Presence bit indicates whether the Maximum Responders field is present.

The Maximum Responders field specifies the maximum number of responders that the initiator can support for MMS ranging (e.g., K≥1). To indicate that the initiator supports one-to-many MMS ranging, the Maximum Responders field in the ADV-POLL frame is set to a value larger than one, and not present in one-to-one ranging.

Upon receiving the ADV-POLL frame, the responders can coordinate their responses and pick N (N≤K) responders to participate in the MMS ranging. The selected N responders transmit their respective ADV-RESP frames, one after another in a coordinated fashion, ensuring that their ADV-RESP frames do not collide with each other. An ADV-RESP frame is used by a responder to request parameters for MMS ranging and is illustrated in FIG. 11, and the key fields are as follows:

Ranging Mode: indicates the mode requested for the MMS ranging, where:
0=One-to-one
1=Serial one-to-many (in this example, Ranging mode field is set to 1)
2=Time Efficient one-to-many
3=Reserved.

Ranging Frame Sequence Decider: indicates whether the responders decide the transmission sequence of the ranging frames during the ranging phase of one-to-many ranging. The sequence may be the same as the transmission sequence of the ADV-RESP frames during the initialization and setup phase. And this bit is reserved for one-to-one ranging.

DS-TWR: indicates that DS-TWR related fields are requested in the measurement report.

Remaining ADV-RESPs: indicates the number of remaining ADV-RESP frames that will be transmitted in the initialization and setup phase following this frame. It is only present when one-to-many ranging is requested. Reserved for one-to-one ranging.

Ranging Parameters: carries parameters particular to the ranging mode, where:
POLL Absent In Control Phases: indicates whether POLL frames are to be skipped in the ranging control phases other than in the first access slot. Reserved for one-to-one ranging.
Consolidated Measurement Report: only a single consolidated measurement report is transmitted after the last access slot. Reserved for one-to-one ranging.
Initiator Report Requested: requests initiator to transmit a measurement report.
Final MMS Packet Requested: requests initiator to transmit an additional MMS packet at the end of the last ranging phase.

All responders transmit ADV-RESP frames with same content except for the Remaining ADV-RESPs field, which is different for each responder. Based on the number of received ADV-RESP frames, the initiator will know how many responders will participate in the ranging phase.

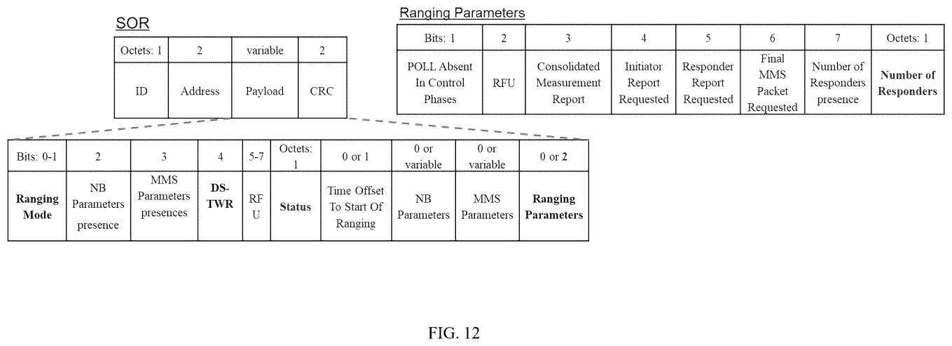

Upon receiving the last ADV-RESP frame (that indicates zero remaining ADV-RESP frame) or once the expected total transmission time for all ADV-RESP frames has elapsed, the initiator transmits the SOR frame indicating the status of the request for MMS ranging; if the status is successful, the time at which the first measurement cycle of the MMS ranging will start and also the number of responders that the initiator will range with during the MMS ranging rounds. In the SOR frame, the initiator also confirms the MMS ranging parameters requested by the responders, and may also suggest MMS ranging parameters that are not requested by the responders. For example, in some use cases, the initiator may decide to enable DS-TWR for the MMS ranging and may set the DS-TWR field to 1 in the SOR frame even if DS-TWR was not requested by the responder in the ADV-RESP frame. The SOR frame is illustrated in FIG. 12 and the key fields are as follows:

Ranging Mode: confirms the mode requested for the MMS ranging:
0=One-to-one
1=Serial one-to-many
2=Time Efficient one-to-many
3=Reserved.

Status: indicates whether the request for ranging is successful or not. The remaining fields in the SOR frame are only present if Status is successful and not present otherwise.

Ranging Parameters: confirms the ranging parameters requested by the responders. In addition, includes:
Responder Report Requested: requests responders to transmit a measurement report.
Number of Responders: indicates the number of responders confirmed for the ranging. For one-to-many MMS ranging this may be based on the number of ADV-RESP frames received by the initiator (e.g., N). Absent for one-to-one ranging.

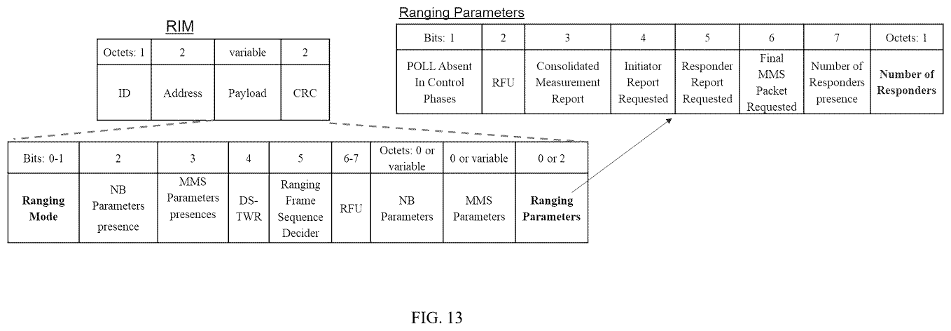

At the time indicated by the time offset in the SOR frame, the initiator transmits a Ranging Initiation Message (RIM) frame (for one-to-one ranging the RIM frame is replaced with a POLL frame), e.g., at the beginning of the first ranging slot of a ranging round. The RIM frame signals the start of the MMS ranging and the initiator re-confirms the parameters requested by the responders and initiator (in the ADV-RESP frames and SOR frame respectively) and may also include other control information for the responders. The RIM frame is illustrated in FIG. 13, and the key fields are as follows:

Ranging Mode: confirms the mode for the MMS ranging, where:
0=One-to-one
1=Serial one-to-many
2=Time Efficient one-to-many
3=Reserved.

DS-TWR: indicates that DS-TWR related fields are requested in the measurement report.

Ranging Frame Sequence Decider: indicates whether the responders decide the transmission sequence of the ranging frames during the ranging phase of one-to-many ranging. Reserved for one-to-one ranging.

Ranging Parameters: specifies parameters particular to the ranging mode, where:
POLL Absent In Control Phases: indicates whether POLL frames will be skipped in the ranging control phases other than in the first access slot. Reserved for one-to-one ranging.
Consolidated Measurement Report: only a single consolidated measurement report is transmitted after the last access slot. Reserved for one-to-one ranging.
Initiator Report Requested: requests initiator to transmit a measurement report.
Responder Report Requested: requests responders to transmit a measurement report.
Final MMS Packet Requested: requests initiator to transmit an additional MMS packet at the end of the last ranging phase.
Number of Responders: specifies the number of responders that will participate in the MMS ranging. Absent for one-to-one ranging.

In the RIM frame, the initiator re-confirms the parameters requested by the responders. The RIM also includes the configuration parameters for the one-to-many ranging round which divides the ranging slots in the ranging round into multiple access slots, with one access slot reserved for one responder. Each access slot may further include the ranging control phase, the ranging phase, and may include the measurement reporting phase as described above. Particularly, in access slot 0 (i.e. the first access slot), the RIM frame also serves the time synchronization function as the POLL frame. In synchronized one-to-many ranging case, the RIM frame indicates the number of responders that will participate in the ranging but does not provide the responders' transmission sequence, i.e., does not allocate responders to the access slots. The responders will decide their own transmission sequence and access slot allocation. The sequence may be the same as the transmission sequence of the ADV-RESP frames during the initialization and setup phase. The Ranging Parameters field in the RIM frame also confirms the ranging parameters requested by the responders (POLL Absent In Control Phases, Consolidated Measurement Report, Initiator Report Requested, Final MMS Packet Requested). In addition, the Responder Report Requested field is set to indicate whether the responders' measurement report(s) is requested, and the Number of Responders field specifies the number of responders that may participate in the one-to-many MMS ranging (e.g., N). When the Consolidated Measurement Report bit is set to 1 in the RIM frame, the measurement reporting phase is not included in the access slots and the initiator reserves slots at the end of the ranging round to transmit consolidated measurement reports from/for all responders.

Upon receiving the RIM frame in the first ranging control phase, in the synchronized one-to-many ranging, the responders can coordinate among themselves and decide which responders will participate in the ranging (if the number of responders indicated in the RIM frame is less than the number of available responders) and their response sequence, i.e., the sequence in which the responders perform MMS ranging with the initiator. The responder that will perform the first MMS ranging with the initiator is referred to as the first responder, the responder that will perform the second MMS ranging is referred to as the second responder, and so on, while the responder that will perform the last MMS ranging is referred to as the last responder. The first responder transmits the first RESP frame back to the initiator. The RIM and RESP frames allow the initiator and responders to achieve time and frequency synchronization. In the ranging phase of the first access slot, the initiator and the first responder perform MMS ranging by exchanging MMS packets including zero or more UWB ranging sequence fragments (RSFs) and zero or more UWB ranging integrity fragments (RIFs). The type of the exchanged MMS packets and the total number of fragments in each MMS packet (e.g., M) may be negotiated beforehand (e.g., during session setup, or in the initialization and setup phase). The RSFs are used to perform ranging measurements while the RIFs are used to check the integrity of the ranging measurements. In the example in FIG. 9, the Consolidated Measurement Report bit is set to 1 in the RIM frame, and hence the measurement reporting phase is not included in the access slots. In the synchronized one-to-many ranging, since all responders are connected to each other, they can maintain clock and frequency synchronization among each other, and hence in the second and subsequent access slots, the responders may request the initiator to skip the transmission of the POLL frame (by setting the POLL Absent In Control Phases bit in the ADV-RESP frames to 1), in which case the ranging control phase of the second and subsequent access slots only allocate slots for the RESP frame. Hence in the second and subsequent access slots, only the responders transmit the RESP frames in the ranging control phase (i.e. the POLL frame is skipped), and each responder perform MMS ranging with the initiator in the ranging phase according to the decided response sequence. If the Final MMS Packet Requested bit is set to 1 in ADV-RESP frame and the RIM frame, i.e., if the responders requested the initiator to transmit an additional MMS packet at the end of the last ranging phase, the initiator transmits an additional MMS packet at the end of the last Ranging phase. The additional MMS packet acts as the final packet used to make DS-TWR measurements.

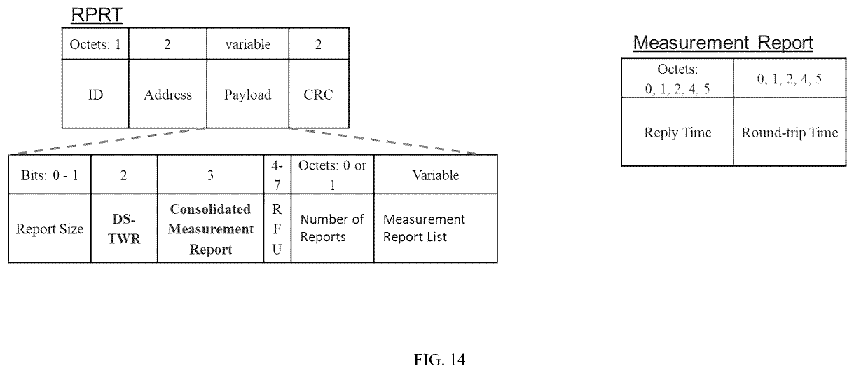

After the initiator and all the responders complete the exchange of MMS packets, the measurement reporting phase starts in which the initiator and each of the responder generate a ranging measurement report, and send the RPRT frames carrying the measurement report to the peer device. In the synchronized one-to-many ranging case, when report is requested from the responders (i.e., the Responder Report Requested bit is set to 1) and consolidated measurement report is indicated (i.e., the Consolidated Measurement Report bit is set to 1 in the RIM frame), one of the responders collects the relevant measurement reports from all responders (e.g., over the vehicle wired network) and generates a consolidated measurement report and transmits the RPRT frame carrying the consolidated measurement report in the first slot of the measurement reporting phase. Similarly, when report is requested from the initiator (i.e., the Initiator Report Requested bit is set to 1), the initiator collects the relevant measurements for all the responders and generates a consolidated measurement report and transmits the RPRT frame carrying the consolidated measurement report in the second slot of the measurement reporting phase. The RPRT frame is illustrated in FIG. 14, and the key fields are as follows:

Report Size: indicates the size of the Reply Time fields and the Round-trip Time fields:
0: 1 octet
1: 2 octets
2: 4 octets
3: 5 octets

DS-TWR: indicates that DS-TWR related fields are present in the measurement report.

Consolidated Measurement Report: indicates that the RPRT frame carries more than one measurement reports. Reserved for one-to-one ranging.

Number of Reports: indicates the number of measurement reports in the Measurement Report List field. If the Consolidated Measurement Report bit is 1, the Number of Reports field is present. Absent in one-to-one ranging.

Measurement Report List: carries one or more Measurement Report fields. For one-to-one ranging, only a single Measurement Report field is present. For one-to-many ranging, two or more Measurement Report fields are present, one field of or for a responder and are arranged in the same order as the transmission order of the corresponding responder in the ranging round.

Measurement Report: each report carries the measurement report of or for one responder, where:

Reply Time: the time difference between the reception time of the MMS packet being responded to and the transmission time of the response MMS Packet.

Round-trip Time: the time difference between the transmission time of the MMS packet initiating a round-trip time measurement and the reception time of the response MMS packet from the peer device that completes the round-trip time measurement. The unit of time is the ranging counter time unit, as decided by IEEE 802.14ab (for example 15.65 ps (as used by HRP UWB PHY in 802.15.4z) or a smaller unit like 1 ps).

If the DS-TWR bit is 0 (e.g., one-to-many ranging with SS-TWR):
for responder's RPRT frame: Reply Time field is present; Round-trip Time field is absent; and
for initiator's RPRT frame: Round-trip Time field is present; Reply Time field is absent.
If the DS-TWR bit is 1 (e.g., one-to-many ranging with DS-TWR):
both Reply Time field and Round-trip Time field are present.

If both the DS-TWR bit and the Consolidated Measurement Report bit are 0 (e.g., for one-to-one ranging with SS-TWR), the Number of Reports field is absent and the RPRT frame carries a single measurement report in the Measurement Report List. Alternatively, instead of the DS-TWR bit, the presence of the Reply Time and Round-Trip Time fields may be indicated by separate presence bits (e.g., Reply Time Presence and Round-trip Time Presence).

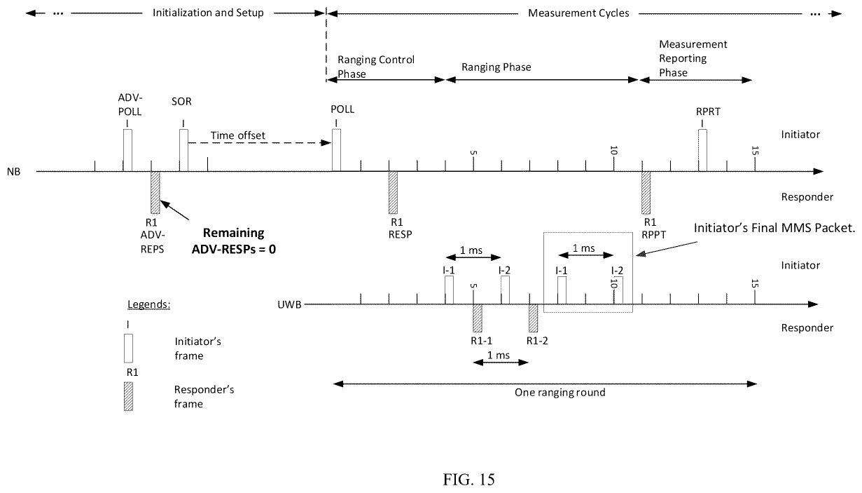

When there is only one controlee, the message flow illustrated in FIG. 9 applies to one-to-one MMS ranging, and the RIM frame is replaced by a POLL frame. FIG. 15 provides a graphical illustration of one-to-one MMS ranging adapted for DS-TWR. In the ADV-POLL frame (as illustrated in FIG. 10), the Initialization And Setup Modes field is set as 0 (i.e., Single Responder). The ADV-RESP frame (illustrated in FIG. 11) is used by a responder to request parameters for one-to-one MMS ranging by setting the Ranging Mode field to 0 (i.e., One-to-one). If DS-TWR is requested, the DS-TWR bit is set to 1. The Remaining ADV-RESPs field is set as 0. For one-to-one MMS ranging, the one-to-many ranging related fields are reserved in the ADV-RESP and SOR frames.

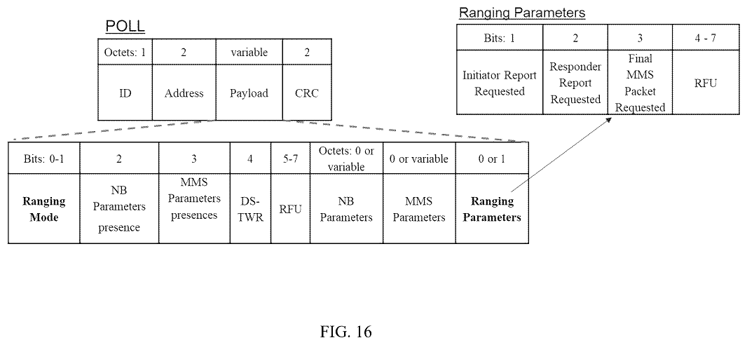

At the time indicated by the time offset in the SOR frame, the initiator transmits a POLL frame, e.g., at the beginning of the first ranging slot of a ranging round. The POLL frame signals the start of the one-to-one MMS ranging, and the initiator re-confirms the parameters requested by the responder and initiator (in the ADV-RESP frames and SOR frame respectively), and may also include other control information for the responders. The POLL frame is illustrated in FIG. 16, and the key fields are as follows:

Ranging Mode: confirms the mode for the MMS ranging, where:
0=One-to-one
1=Serial one-to-many (in this example, Ranging mode field is set to 1)
2=Time Efficient one-to-many
3=Reserved.

DS-TWR: indicates that DS-TWR related fields are requested in the measurement report.

Ranging Parameters: specifies parameters particular to the ranging mode, where:
Initiator Report Requested: requests initiator to transmit a measurement report.
Responder Report Requested: requests responder to transmit a measurement report.
Final MMS Packet Requested: requests initiator to transmit an additional MMS packet at the end of the last ranging phase.

Upon receiving the POLL frame, the responder transmits the RESP frame back to the initiator. The POLL and RESP frames allow the initiator and the responder to achieve time and frequency synchronization. In the ranging phase, the initiator and the responder perform MMS ranging by exchanging MMS Packets. In this example, each MMS Packet is made up of two fragments. If the Final MMS Packet Requested bit is set to 1 in ADV-RESP frame and the POLL frame, i.e., if the responder requested the initiator to transmit an additional MMS packet at the end of the last ranging phase, the initiator transmits an additional MMS packet at the end of the ranging phase. Alternatively, when RSF-only MMS packets are used for the MMS ranging, and DS-TWR measurements are requested (i.e., the DS-TWR bit is set to 1 in the ADV-RESP frame), the initiator may transmit the additional MMS packet even when the final MMS Packet is not explicitly requested by the responder (i.e., the Final MMS Packet Requested bit is not set to 1 in ADV-RESP frame), and sets the Final MMS Packet Requested bit to 1 in the SOR frame and the POLL frame. When RSF-only MMS packets are used for the MMS ranging, the additional MMS packet acts as the final packet used to make DS-TWR measurements when the DS-TWR bit is set to 1 in the ADV-RESP frame. After the initiator and the responder complete the exchange of MMS packets, the measurement reporting phase starts in which the initiator (if Initiator Report Requested bit is set to 1) and the responder (if Responder Report Requested bit is set to 1) generate a ranging measurement report, and send the RPRT frames carrying the measurement report to the peer device. When the DS-TWR bit is set to 1 in the ADV-RESP frame, both the Round-trip Time field and the Reply Time field are included in the measurement report.

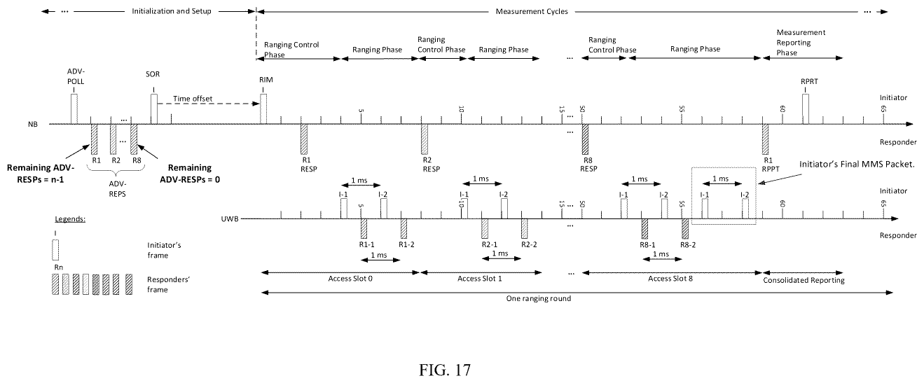

FIG. 17 illustrates the synchronized one-to-many example given in FIG. 9 in the time domain format. Here, the number of responders (N) is equal to eight and the number of fragments in the MMS packet (M) is two. During the measurement cycles, each bar in the horizontal line represents one slot (e.g., of 0.5 ms duration). The key points related to the present disclosure may be as follows:
In the initialization and setup phase, the responders coordinate their responses and transmit the respective ADV-RESP frames in a coordinated manner. Each ADV-RESP frame indicates the number of remaining ADV-RESP frames. The initiator transmits the SOR frame after the last ADV-RESP frame.
In the ranging control phase of access slots other than the first access slot, POLL frame is skipped if POLL Absent In Control Phases bit is set to 1 in applicable frames and only the RESP frame is transmitted. If the POLL Absent In Control Phases bit is not set to 1, a POLL frame as illustrated in FIG. 16 will be transmitted by the initiator two slots prior to the transmission time of the RESP frame.
If requested (e.g., Final MMS Packet Requested bit is set to 1 in ADV-RESP frame to enable DS-TWR), in the ranging phase of the last access slot, the initiator transmits one additional MMS packet after receiving the MMS packet from the last responder. Alternatively, when RSF-only MMS packets are used for the MMS ranging that uses RSF-only MMS packets, and DS-TWR measurements are requested (i.e., the DS-TWR bit is set to 1 in the ADV-RESP frame), the initiator may transmit the additional MMS packet even when the final MMS Packet is not explicitly requested by the responders (i.e., the Final MMS Packet Requested bit is not set to 1 in ADV-RESP frames), and sets the Final MMS Packet Requested bit to 1 in the SOR frame and the RIM frame as applicable.
The RPRT (Report) frames are only transmitted after the last access slot. If responder's consolidated measurement report is requested, the uplink RPRT frame may carry the consolidated measurement report of all responders. If initiator's consolidated measurement report is requested, the downlink RPRT frame may carry the consolidated measurement report for all responders.

It can be seen from FIG. 17 that one measurement cycle can be completed in 62 slots (31 ms). Without any special measures (e.g., not skipping the POLL frames, or not using consolidated measurement reports), if the default serial one-to-many ranging sequence shown in FIG. 4 is employed, one measurement cycle can only be completed in 80 slots (40 ms), i.e., takes 9 ms more. Furthermore, the default serial one-to-many ranging sequence shown in FIG. 4 may not support DS-TWR.

Next, the present disclosure describes how the ranging measurements to enable DS-TWR (e.g., if the DS-TWR bit is set to 1 in the ADV-RESP frame or the SOR frame) are made and reported. Three MMS fragments with RMARKERs are required to make timing measurements for DS-TWR. Mixed MMS packets or RIF-only MMS packets with at least two fragments have at least two RMARKERs that can be used to compute the timing measurements for DS-TWR. This means, a single MMS packet exchange between the initiator and the responder is sufficient for DS-TWR timing measurements when mixed MMS packets or RIF-only MMS packets with at least two fragments are used for MMS ranging. In this case the additional MMS packet (shown as the final MMS Packet in FIG. 17) is not required from the initiator.

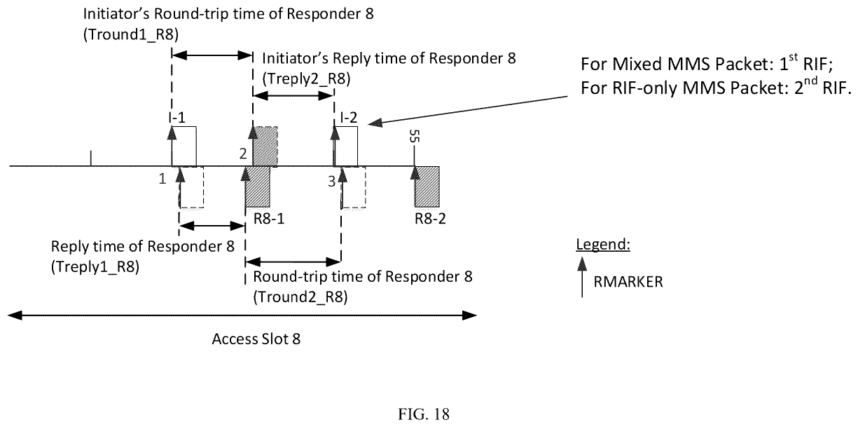

A close up view of the UWB MMS packet exchange between the initiator and the last responder (i.e., responder 8) in the 8^{th} access slot of FIG. 17, is illustrated in FIG. 18. In this example, the MMS packet may be Mixed MMS packet or RIF-only MMS packet. In either case, as explained earlier and shown in FIG. 18, both fragments of the MMS packets contain the RMARKERs that can be used to make timing measurements. For Mixed MMS packet with a single RIF, the first RMARKER is the RSF-RMARKER in the first RSF of the initiator's MMS packet to the responder, the second RMARKER is the RSF-RMARKER in the first RSF of the responder's MMS packet, and the third RMARKER is the RIF-RMARKER in the first RIF of the initiator's MMS packet to the responder. For Mixed MMS packet with more than one RIFs, it is more secure to use the RIF-RMARKERs for timing measurements and hence the RIF-RMARKERs of the first two RIFs of the initiator's MMS packet are used as the first and the third RMARKERs, while the RIF-MARKER of the first RIF of the responder's MMS packet is used as the second RMARKER. For RIF-only MMS packet, the RIF-RMARKERs of the first two fragments of the initiator's MMS packet are used as the first and the third RMARKERS, while the RIF-MARKER of the first fragment of the responder's MMS packet is used as the second RMARKER.

When Mixed MMS packet or RIF-only MMS packet with at least two fragments is used for MMS ranging, a single MMS packet exchange is enough for DS-TWR since each MMS packet contains at least two RMARKERs that can be used to make timing measurements. The initiator records the timing of the concerned RMARKERs and computes the required times (Round-trip time (Tround1_Rn), Reply time (Treply2_Rn)) for each responder as described below. Each of the responders records the timing of the concerned RMARKERs and computes the required times (Reply time (Treply1_Rn), Round-trip time (Tround2_Rn)) as described below. The fields of each Measurement Report (see FIG. 14) is set as:
Initiator's measurement report (for Responder n):
   Round-trip time (Tround1_Rn)=Time difference between the transmission time of the RMARKER of the first fragment of the initiator's MMS packet to Responder n and the reception time of the RMARKER of the first fragment of the Responder n's MMS packet.
   Reply time (Treply2_Rn)=Time difference between the reception time of the RMARKER of the first fragment of the Responder n's MMS packet and the transmission time of the RMARKER of the next fragment of the initiator's MMS packet that carries a RMARKER.
Responder's measurement report (from Responder n):
   Reply time (Treply1_Rn)=Time difference between the reception time of the RMARKER of the first fragment of the initiator's MMS packet to Responder n and the transmission time of the RMARKER of the first fragment of the Responder n's MMS packet.
   Round-trip time (Tround2_Rn)=Time difference between the transmission time of the RMARKER of the first fragment of the Responder n's MMS packet and the reception time of the RMARKER of the next fragment of the initiator's MMS packet that carries a RMARKER.

As explained earlier, for Mixed MMS packet with more than one RIFs, it is more secure to use the RIF-RMARKERs for timing measurements. In this case the fields of each Measurement Report (see FIG. 14) is set as:
Initiator's measurement report (for Responder n):
   Round-trip time (Tround1_Rn)=Time difference between the transmission time of the RMARKER of the first RIF of the initiator's MMS packet to Responder n and the reception time of the RMARKER of the first RIF of the Responder n's MMS packet.
   Reply time (Treply2_Rn)=Time difference between the reception time of the RMARKER of the first RIF of the Responder n's MMS packet and the transmission time of the RMARKER of the second RIF of the initiator's MMS packet.
Responder's measurement report (from Responder n):
   Reply time (Treply1_Rn)=Time difference between the reception time of the RMARKER of the first RIF of the initiator's MMS packet to Responder n and the transmission time of the RMARKER of the first RIF of the Responder n's MMS packet.
   Round-trip time (Tround2_Rn)=Time difference between the transmission time of the RMARKER of the first RIF of the Responder n's MMS packet and the reception time of the RMARKER of the second RIF of the initiator's MMS packet.

When DS-TWR is requested, i.e., the DS-TWR bit is set to 1 in the ADV-RESP frame or the SOR frame, both the Round-trip Time field and the Reply Time field are included in the measurement report(s), else the initiator's measurement report only includes the Round-trip Time field and the responder's measurement report only includes the Reply Time field. Once a device (initiator or responder) receives the measurement reports from the peer device, it can compute the DS-TWR TOF using Equation 1, and hence estimate the range of the peer device.

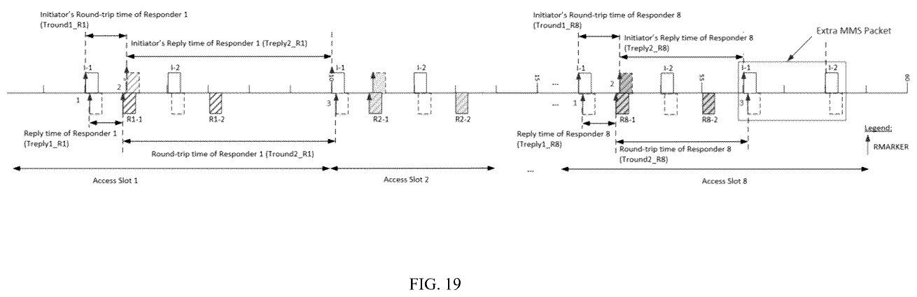

Next, the present disclosure describes the scenario in which the MMS packets used for MMS ranging have a single fragment with RMARKER (for example when RSF-only MMS packets are used, or a RIF-only MMS packet with a single fragment is used). In this case, an additional MMS packet from the initiator may be required to enable DS-TWR. A close up view of the MMS packet exchange between the initiator and the first two responders and the last responder (i.e., responder 8) in the 8th access slot (in FIG. 17) is illustrated in FIG. 19. In this example, the MMS packets are RSF-only MMS packets. In this case, as explained earlier and shown in FIG. 19, only the first fragment (RSF) of the MMS packet contains an RMARKER that can be used to make timing measurements. Three RMARKERs are required to make timing measurements for DS-TWR. In this case for all responders except the last responder, the first RMARKER is the RMARKER in the first fragment (for example the RSF-RMARKER in the first RSF or the first RIF-RMARKER in the first RIF) of the initiator's MMS packet for the responder (i.e., the I-1 fragment at the beginning of the respective access slot). The second RMARKER is the RMARKER in the first fragment of the responder's MMS packet for the initiator (i.e., the Rn-1 fragment), while the third RMARKER is the RMARKER in the first fragment (for example the RSF-RMARKER in the first RSF or the first RIF-RMARKER in the first RIF) of the initiator's MMS packet for the next responder (i.e., the I-1 fragment at the beginning of the next access slot). This is illustrated in the left half of FIG. 19. However, for the last responder, since the next responder doesn't exist, an additional MMS packet (shown as the final MMS packet in FIG. 17 and as additional MMS packet in FIG. 19) is required from the initiator to enable DS-TWR timing measurements. For the last responder, the first RMARKER is the RSF-RMARKER (in the first RSF) of the initiator's MMS packet for the last responder (i.e., the I-1 fragment at the beginning of access slot 8), the second RMARKER is the RMARKER in the first fragment of the last responder's MMS packet for the initiator (i.e., the R8-1 fragment), while the third RMARKER is the RSF-RMARKER (in the first RSF) of the additional MMS packet from the initiator (i.e., the I-1 fragment at the end of access slot 8). This is illustrated in the right half of FIG. 19.

When MMS packets used for MMS ranging have a single fragment with RMARKER (for example when RSF-only MMS packets are used, or a RIF-only MMS packet with a single fragment is used), the RMARKERs are determined as described above and the initiator records the timing of the concerned RMARKERs and computes the required times (Round-trip time (Tround1_Rn), Reply time (Treply2_Rn)) for each responder as described below. Each of the responders records the timing of the concerned RMARKERs and computes the required times (Reply time (Treply1_Rn), Round-trip time (Tround2_Rn)) as described below. The fields of each Measurement Report (see FIG. 14) is set as:
Initiator's measurement report (for Responder n except the last Responder):
   Round-trip time (Tround1_Rn)=Time difference between the transmission time of the RMARKER of the first fragment of the initiator's MMS packet to Responder n and the reception time of the RMARKER of the first fragment of the Responder n's MMS packet.
   Reply time (Treply2_Rn)=Time difference between reception time of the RMARKER of the first fragment of the Responder n's MMS packet and the transmission time of the RMARKER of the first fragment of the initiator's MMS packet to the next responder (n+1).
Responder's measurement report (from Responder n except the last Responder):
   Reply time (Treply1_Rn)=Time difference between the reception time of the RMARKER of the first fragment of the initiator's MMS packet to Responder n and the transmission time of the RMARKER of the first fragment of the Responder n's MMS packet.
   Round-trip time (Tround2_Rn)=Time difference between the transmission time of the RMARKER of the first fragment of the Responder n's MMS packet and the reception time of the RMARKER of the first fragment of the initiator's MMS packet to the next responder (n+1).
For the last responder, the additional MMS packet from the initiator is used as the MMS packet to the next responder (n+1) to compute the DS-TWR timing measurements (i.e., the initiator's reply time to the last responder and the round-trip time of the last responder).

In the above example 1, each of the multiple responders transmits an ADV-RESP frame to the initiator during the initialization and setup phase. In an embodiment, one responder may be predetermined or dynamically selected from multiple responders to participate in MMS ranging, and the one responder transmits one ADV-RESP frame to the initiator, then, the initiator transmits the SOR frame to the one responder, thereby improving the processing efficiency of the initialization and setup phase, and a unified initialization and setup procedure is achieved. Upon receiving one ADV-RESP frame from the one responder, the initiator determines that only one responder transmits one ADV-RESP frame, and transmits the SOR frame. Thus, the collision of the ADV-RESP frames with each other or with the SOR frame is prevented.

With regard to the indication manner of the number N indicated by the ADV-RESP frame, in an embodiment, the ADV-RESP frame may include a first indication and a second indication, the first indication is used to indicate the number N, and the second indication is used to indicate a number of a remaining ADV-RESP frame to be transmitted following the ADV-RESP frame, the number of the remaining ADV-RESP frame included in an i-th ADV-RESP frame is N−i, and 1≤i≤N. The first indication may be the Number of Responders field in the ADV-RESP frame, and the second indication may be the Remaining ADV-RESPs field in the ADV-RESP frame. In an embodiment, the second indication is used to indicate a number of a remaining first frame is 0. The joint indication manner may be suitable for the scenario where only one ADV-RESP frame is transmitted by one responder to the initiator. On one hand, the first indication may indicate the number of responders that will participate in MMS ranging. On the other hand, the second indication may indicate that the number of remaining ADV-RESP frame is 0. Thus, after receiving the ADV-RESP frame including the first indication and the second indication, the initiator may learn that it is time to transmit the SOR frame.

In an embodiment, an MMS packet from the initiator is skipped in an access slots other than a first access slot and a last access slot in the MMS ranging, the communication method further includes: the initiator transmits a final MMS packet in a last access slot in the MMS ranging. That is, the initiator will not transmit an MMS packet in each access slot in measurement cycles, thereby reducing the ranging time.

In an embodiment, when N is even, the communication method further includes: the initiator determines that an MMS packet used for the MMS ranging is an MMS packet including a single fragment with a ranging marker; and transmits the final MMS packet in the last access slot in the MMS ranging after receiving a first fragment of an MMS packet transmitted by an N-th responder. An MMS packet including a single fragment with a ranging marker may be an RIF-only MMS packet with a single fragment or an RSF-only MMS packet. Through reversing the order of the MMS packet exchange in the last access slot, an additional MMS packet from the initiator may be unnecessary, and DS-TWR can still be enabled.

Correspondingly, the present disclosure modifies the acquiring process of the first round-trip time and the first reply time in initiator's measurement report, the second round-trip time and the second reply time in responder's measurement report.

In an embodiment, the initiator records a seventh transmission time of a first ranging marker of a first fragment of a first MMS packet from the initiator in a first access slot, a fourth reception time of a second ranging marker of a first fragment of a second MMS packet from the N-th responder to the initiator, and an eighth transmission time of a third ranging marker of a first fragment of a third MMS packet from the initiator in a last access slot; and computes the first round-trip time and the first reply time according to the seventh transmission time, the fourth reception time, and the eighth transmission time. In an embodiment, the N-th responder records a twelfth reception time of a first ranging marker of a first fragment of a first MMS packet from the initiator in a first access slot, a fourteenth transmission time of a second ranging marker of a first fragment of a second MMS packet from the N-th responder to the initiator, and a thirteenth reception time of a third ranging marker of a first fragment of a third MMS packet from the initiator in a last access slot; and computes the second round-trip time and the second reply time according to the twelfth reception time, the fourteenth transmission time, and the thirteenth reception time. The DS-TWR can be enabled based on the reversing of the order of the final MMS packet exchange in the last access slot when an MMS packet used for the MMS ranging is an MMS packet including a single fragment with a ranging marker and when N is even.

The above mainly describes embodiments for scenarios which are different from example 1. It should be noted that, some similar processes for the MMS ranging in example I may also be applied to the scenarios, which are not repeated herein.

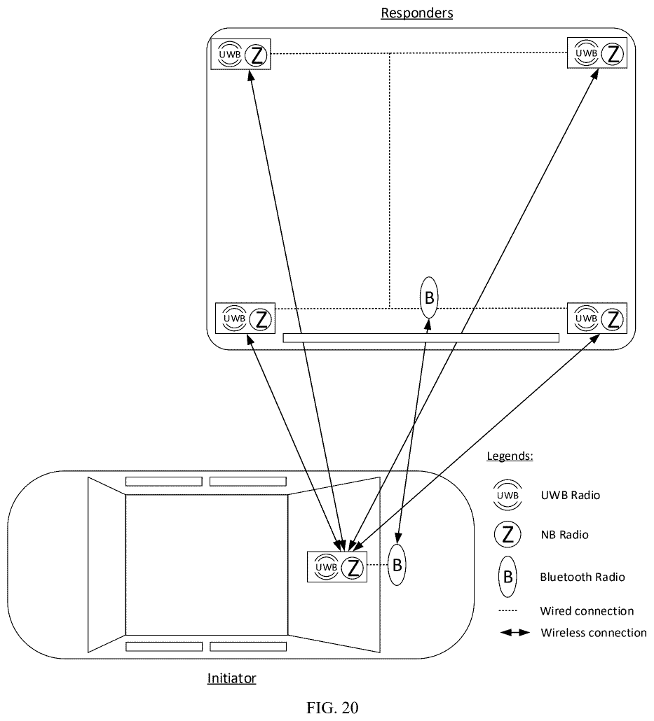

Another digital key application scenario (e.g., digital key for garage door, or front gate opening) illustrated in FIG. 20 is taken as example 2, and there may be other scenarios, which is not limited herein. Several NB-UWB modules may be installed in various locations (e.g., at the four corners of a garage) to act as responders. One or more Bluetooth radios may also be installed. All these radios are also connected to each other, for example, using in-house wired networks and are able to communicate with each other. There may be a central device that can control and coordinate all the radios. One of the NB-UWB modules may also act as a proxy-responder. The responder to act as the proxy-responder may be statically selected, e.g., based on device capability and/or its location in the garage etc. Or, the proxy responder may be dynamically selected, e.g., based on the received signal strength of the ADV-POLL frame during the initialization and setup phase. The responder that receives the ADV-POLL frame with highest signal power may act as the proxy-responder.

The UWB, NB and Bluetooth radios may be directly installed in the vehicle (e.g., a car), as shown in FIG. 7 and one of the NB-UWB modules acts as the initiator. Alternatively, a compatible mobile device (e.g., smartphone) that supports one each of the UWB, NB and Bluetooth radio and carried by the driver of a car acts as the initiator for MMS ranging. The Bluetooth radio is used for the initial discovery, connection setup and credential validations, while the NB and UWB radios are used for the MMS ranging. Since NBA-UWB MMS ranging is designed for long distance ranging, it is suitable for such use case that requires ranging from a larger distance, e.g., while the car is still 50 meters or more away, it can initiate the ranging procedure to open the garage door/gate. By the time the car is near the garage/gate (e.g., 10 meters away), it can already be authenticated to be an authorized vehicle (based on digital key information as well as the distance etc.), and an appropriate action can be taken, such as opening the garage door or front gate, all the while without requiring the car to slow down or stop to wait for the door/gate opening.

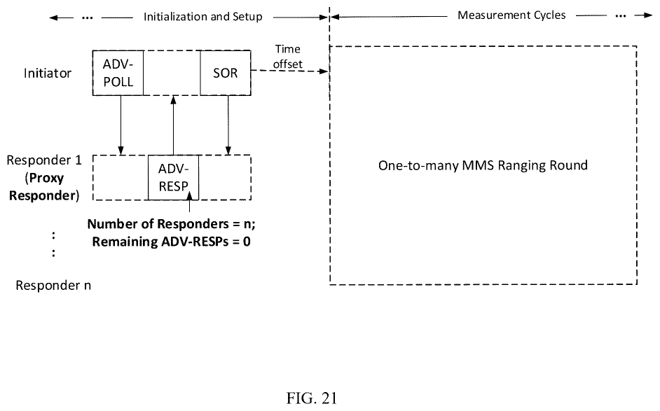

In the initialization and setup phase of MMS ranging, an initiator transmits advertising poll (ADV-POLL) frames opportunistically at times and intervals to its discretion while responder(s) may opportunistically listen for incoming ADV-POLL frames. In this scenario, only the proxy-responder responds to the ADV-POLL frame with an ADV-RESP frame as illustrated in FIG. 21. The ADV-RESP frame indicates the number of responders that will participate in the MMS ranging. The number of responders may be determined based on how many responders received the ADV-POLL frame etc. The ADV-RESP frame may also indicate that the number of remaining ADV-RESP frames that will be transmitted following the frame is zero since this is the only ADV-RESP frame.

When the initiator receives an ADV-RESP frame, based on the Number of Responders field, it can determine whether one-to-one or one-to-many MMS ranging is requested. When the Number of Responders field is set to a value greater than one, it is alerted that one-to-many MMS ranging is requested and that more than one responder will participate in the MMS ranging. Since the ADV-RESP frame also indicates zero remaining ADV-RESP frames, the initiator transmits the SOR frame that indicates when the MMS ranging will start. Thus, the collision of the ADV-RESP frames with each other or with the SOR frame is prevented.

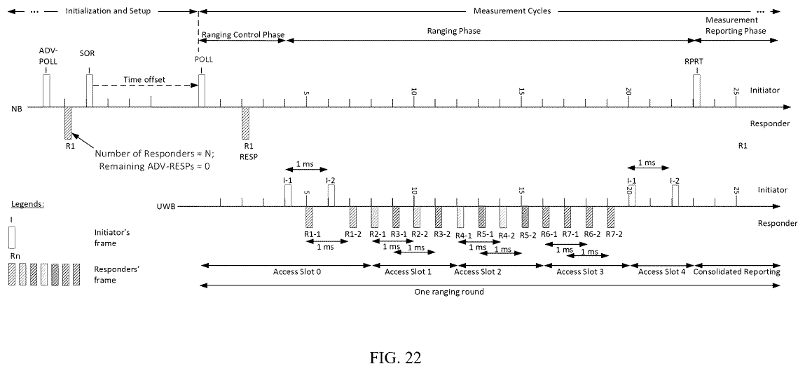

An example time domain message flow of a one-to-many UWB MMS ranging application that is adapted for DS-TWR with multiple coordinated responders and a proxy-responder is illustrated in FIG. 22.

The message flow is similar to that illustrated in FIG. 9 and described earlier and is not repeated here. Only the aspects that are different are described. The module in the car (either the NB-module in the car or a mobile device (e.g., smartphone)) acts as the controller and initiator, while the NB-UWB modules in the garage act as the controlees and responders.

Once the session has been setup, the initiator transmits the ADV-POLL frames opportunistically at times and intervals to its discretion while responder(s) may opportunistically listen for incoming ADV-POLL frames and respond with the ADV-RESP frame if the responder intends to participate in a ranging session with the initiator. The Maximum Responders field in the ADV-POLL specifies the maximum number of responders that the initiator can support for MMS ranging (e.g., K≥1). To indicate that the initiator supports one-to-many MMS ranging, the Maximum Responders field in the ADV-POLL is set to a value larger than one.

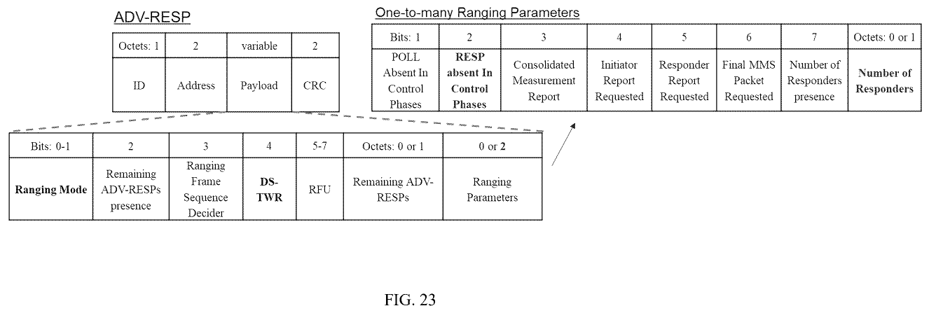

Upon receiving the ADV-POLL frame, the proxy-responder can pick N (N≤K) responders to participate in the MMS ranging and transmits an ADV-RESP frame to request parameters for MMS ranging. The ADV-RESP frame is illustrated in FIG. 23 and the key fields that are different from FIG. 11 are as follows:

Remaining ADV-RESPs: always set to 0 to indicate that this is the only ADV-RESP frame that will be transmitted in the initialization and setup phase.

Ranging Parameters: carries parameters corresponding to the MMS ranging, where:
RESP Absent In Control Phases: set to 1 to indicate that RESP frames are skipped in the ranging control phases other than in the first access slot.
Number of Responders: indicates the number of responders that will participate in ranging.

Here, the ADV-RESP frame also requests that POLL frames be skipped in the ranging control phases other than in the first access slot and also requests DS-TWR time measurements as well as consolidated measurement report.

Upon receiving the ADV-RESP frame, the initiator transmits the SOR frame indicating the status of the request for MMS ranging; if the status is successful, the time at which the first measurement cycle of the MMS ranging will start and also the number of responders that the initiator will range with during the MMS ranging rounds. The SOR frame also confirms the MMS ranging parameters requested by the responders.

At the time indicated by the time offset in the SOR frame, the initiator transmits a POLL frame (illustrated in FIG. 16), e.g., at the beginning of the first ranging slot of a ranging round. The POLL frame signals the start of the one-to-many MMS ranging and the initiator re-confirms the parameters requested by the responders and initiator (in the ADV-RESP frame and the SOR frame respectively) and may also include other control information for the responders.

Upon receiving the POLL frame in the first access slot, the proxy-responder transmits the RESP frame back to the initiator. The POLL and RESP frames allow the initiator and the proxy-responder to achieve time and frequency synchronization. Since all responders are connected with each other, this also allows the other responders to achieve time and frequency synchronization with the initiator. In the ranging phase of the first access slot, the initiator and the proxy-responder perform MMS ranging by exchanging MMS packets. Since the initiator and all responders have already achieved synchronization via the POLL frame and the RESP frame in the first access slot, the POLL frame and the RESP frame (and hence the ranging control phase) are skipped in the subsequent access slots. In the ranging phase of the access slots other than the first access slot and the last access slot, the MMS packets from the initiator are also skipped and only the responders transmit the MMS packet, the MMS fragments of two responders being interleaved within a 1 ms time period. The sequence and order of the responders MMS fragments may be decided by the proxy-responder or by the central controller. In the ranging phase of the last access slot, the initiator transmits the final MMS packet when DS-TWR is requested. If there are even number of responders, the last responder also transmits its MMS packet in the last access slot, the MMS fragments interleaved with the initiator's MMS fragment, but if there are odd number of responders, the last access slot only consists of the initiator's MMS packet as shown in FIG. 22. This means that the access slots other than the first access slot only consist of the ranging phase. Upon completion the ranging phases of all access slots, slots are assigned for measurement reporting phase in which, if report is requested (i.e., the Responder Report Requested bit is set to I in the SOR and POLL frames), and consolidated measurement report is indicated (i.e., the Consolidated Measurement Report bit is set to 1 in the POLL frame), the proxy-responder collects the relevant measurement reports from all responders (e.g., over the home wired network) and generates a consolidated measurement report and transmits the RPRT frames carrying the consolidated measurement report in the first slot of the measurement reporting phase. Similarly, when report is requested from the initiator (i.e., the Initiator Report Requested bit is set to 1), the initiator collects the relevant measurements for all the responders and generates a consolidated measurement report and transmits the RPRT frames carrying the consolidated measurement report in the second slot of the measurement reporting phase. It can be seen from FIG. 22 that, one measurement cycle can be completed in 24 slots (i.e., 12 ms), which is much shorter than the time required for one measurement cycle in example 1.

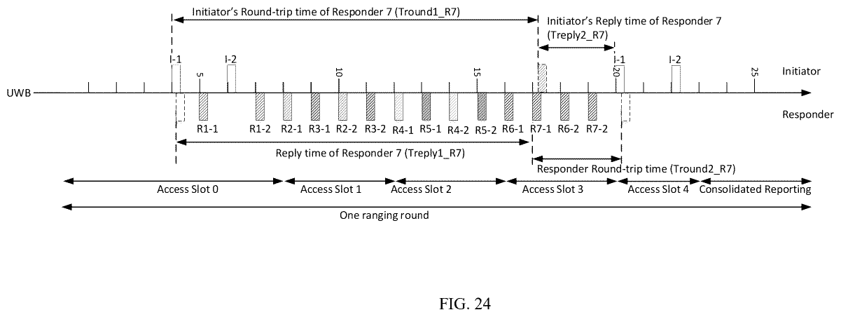

Next, the present disclosure describes how the ranging measurements to enable DS-TWR (if the DS-TWR bit is set to 1 in the ADV-RESP frame or the SOR frame) are made and reported. A close up view of the UWB MMS packet exchange between the initiator and the responders of FIG. 22, is illustrated in FIG. 24.

As explained earlier, when there are odd number of responders, the last access slot only consists of the initiator's MMS packet, and hence the last MMS packet will always be from the initiator. Here, regardless of the MMS packet type, the RMARKER of the first fragment of the initiator's last MMS packet is used as the third RMARKER for all DS-TWR timing measurements. The initiator records the timing of the concerned RMARKERs and computes the required times (Round-trip time (Tround1_Rn), Reply time (Treply2_Rn)) for each responder as described below. Each of the responders records the timing of the concerned RMARKERs and computes the required times (Reply time (Treply1_Rn), Round-trip time (Tround2_Rn)) as described below. The fields of each measurement report (see FIG. 14) is set as:
Initiator's measurement report (for responder n):
   Round-trip time (Tround1_Rn)=Time difference between the transmission times of the RMARKER of the first fragment of the initiator's first MMS packet (e.g., the I-1 fragment at the beginning of access slot 0) and the reception time of the RMARKER of the first fragment of the Responder n's MMS packet (e.g., R7-1 for responder 7).
   time (Treply2_Rn)=Time difference between reception time of the RMARKER of the first fragment of the Responder n's MMS packet (e.g., R7-1 for responder 7) and the transmission time of the RMARKER of the first fragment of the initiator's final MMS packet (e.g., the I-1 fragment at the beginning of access slot 4).
Responder's measurement report (from responder n):
   Reply time (Treply1_Rn)=Time difference between the reception time of the RMARKER of the first fragment of the initiator's first MMS packet (e.g., the I-1 fragment at the beginning of access slot 0) and the transmission time of the RMARKER of the first fragment of the Responder n's MMS packet (e.g., R7-1 for responder 7).
   Round-trip time (Tround2_Rn)=Time difference between the transmission time of the RMARKER of the first fragment of the Responder n's MMS packet (e.g., R7-1 for responder 7) and the reception time of the RMARKER of the first fragment of the initiator's final MMS packet (e.g., the I-1 fragment at the beginning of access slot 4).

When DS-TWR is requested (i.e., DS-TWR bit is set to 1), both Round-trip Time field and Reply Time field are present in the Measurement Report fields, else the initiator's measurement report only includes the Round-trip time and a responder's measurement report only includes the Reply time. Once a device (initiator or responder) receives the measurement reports from the peer device, it can compute the DS-TWR TOF using Equation 1, and hence estimate the range of the peer device.

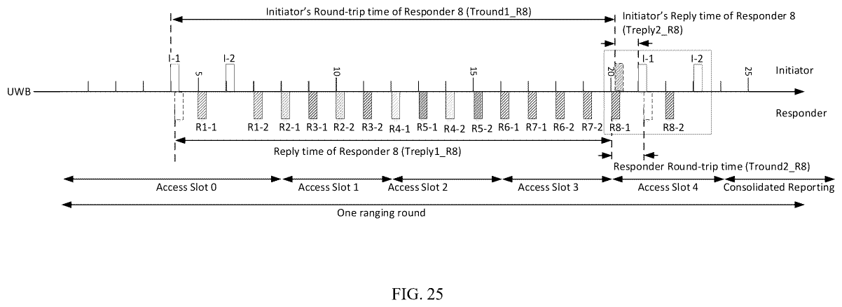

Next, the present disclosure describes how the ranging measurements to enable DS-TWR (if the DS-TWR bit is set to 1 in the ADV-RESP frame or the SOR frame) are made and reported when there are even number of responders. A close up view of the UWB MMS packet exchange between the initiator and the responders of FIG. 22, adapted for even number of responders, is illustrated in FIG. 25. When there are even number of responders, the last responder also transmits its MMS packet in the last access slot, its MMS fragments are interleaved with the initiator's MMS fragment. The order of the initiator's and responder's MMS packets do not matter for Mixed MMS packet and RIF-only MMS packet with at least two fragments with RMARKERs since both packet format consist of at least two RMARKERs which can be used for timing measurements. However, when MMS packets with a single fragment with RMARKER (e.g., RSF-only MMS packet or RIF-only MMS packet with a single fragment) is used and there are even number of responders, since each MMS packet contains a single fragment with an RMARKER, in this case the initiator needs to transmit its final MMS packet only after receiving the first fragment of the MMS packet transmitted by the last responder. This means, in the last access slot, the final ranging fragments are transmitted by the initiator. i.e., the fragment interleaving is reversed (responder transmits first, followed by the initiator). This enables DS-TWR measurements for the last responder as well regardless of the type of the MMS Packet. If the fragment interleaving is not reversed, an additional MMS packet from the initiator is needed to enable DS-TWR if RSF-only MMS packets are used as explained earlier in example 1. The timing measurements are same as for the case of odd number of responders.

Example 2 mainly introduces only one responder transmitting the ADV-RESP frame in the initialization and setup phase and a method to enable DS-TWR without requesting the initiator to transmit an additional MMS packet. In the above example 2, the joint indication manner is implemented through the first indication (for example, the Number of Responders field) and the second indication (for example, the Remaining ADV-RESPs field), there may be another joint indication manner as follows.

In an embodiment, the ADV-RESP frame includes a first indication, and the first indication is used to indicate the number N, when N≥2, the ADV-RESP frame further includes a third indication, and the third indication is used to indicate that N responders are synchronized with each other. The first indication may be the Number of Responders field in the ADV-RESP frame, and the third indication may be the Synchronized Responders field in the ADV-RESP frame. In this case, one of N responders transmits an ADV-RESP frame with the third indication being valid (for example, the Synchronized Responders field being set to 1) to the initiator, when receiving the ADV-RESP frame, the initiator will understand that this is the only ADV-RESP frame, and will proceed to transmit the SOR frame.

In addition, there may be other scenarios where DS-TWR is enabled without requesting the initiator to transmit an additional MMS packet. In an embodiment, the ADV-RESP frame further includes a twelfth indication for requesting to reverse fragment interleaving in a last access slot in the MMS ranging; the communication method further includes: the initiator transmits an MMS packet in the last access slot after receiving a first fragment of an MMS packet transmitted by an N-th responder. The twelfth indication may be the End With Initiator Packet field in the ADV-RESP frame. For example, if the End With Initiator Packet field is set to 1, it is requested to reverse fragment interleaving in a last access slot in the MMS ranging. Through reversing the order of the MMS packet exchange in the last access slot, an additional MMS packet from the initiator may be unnecessary, and DS-TWR can still be enabled.

In an embodiment, when reversing of fragment interleaving in a last access slot in the MMS ranging is not requested in the ADV-RESP frame; the communication method further includes: the initiator determines that an MMS packet used for the MMS ranging is an MMS packet including a single fragment with a ranging marker; sets a thirteenth indication for requesting to reverse fragment interleaving in a last access slot in the MMS ranging in the SOR frame to be valid; and transmits an MMS packet in the last access slot after receiving a first fragment of an MMS packet transmitted by an N-th responder. The thirteenth indication may be the End With Initiator Packet field in the SOR frame. An MMS packet including a single fragment with a ranging marker may be an RIF-only MMS packet with a single fragment or an RSF-only MMS packet. In the scenario where the MMS packet used for the MMS ranging has a single fragment with RMARKER, reversing of fragment interleaving in a last access slot in the MMS ranging may be required to enable DS-TWR. In the case that the reversing of fragment interleaving in the last access slot in the MMS ranging is not requested in the ADV-RESP frame, for example, the End With Initiator Packet field is set to 0 in the ADV-RESP frame, the End With Initiator Packet field in the SOR frame may be set to 1, thus reversing of fragment interleaving in the last access slot in the MMS ranging may still be requested to enable DS-TWR.

For a last access slot, in an embodiment, the initiator records a third transmission time of a first ranging marker of a first fragment of a first MMS packet from the initiator to an (N−1)-th responder, a second reception time of a second ranging marker of a first fragment of a second MMS packet from the N-th responder to the initiator, and a fourth transmission time of a third ranging marker of a first fragment of a third MMS packet from the initiator to the N-th responder; and computes the first round-trip time and the first reply time according to the third transmission time, the second reception time, and the fourth transmission time. In an embodiment, the N-th responder records an eighth reception time of a first ranging marker of a first fragment of a first MMS packet from the initiator to an (N−1)-th responder, a twelfth transmission time of a second ranging marker of a first fragment of a second MMS packet from the N-th responder to the initiator, and a ninth reception time of a third ranging marker of a first fragment of a third MMS packet from the initiator to the N-th responder; and computes the second round-trip time and the second reply time according to the eighth reception time, the twelfth transmission time, and the ninth reception time. The DS-TWR for the N-th responder (last responder) can be enabled based on the reversing of fragment interleaving in the last access slot when an MMS packet used for the MMS ranging is an MMS packet including a single fragment with a ranging marker.

The above mainly describes embodiments for scenarios which are different from example I and example 2. It should be noted that, some similar processes for the MMS ranging in example 1 and example 2 may also be applied to the scenarios, which are not repeated herein.

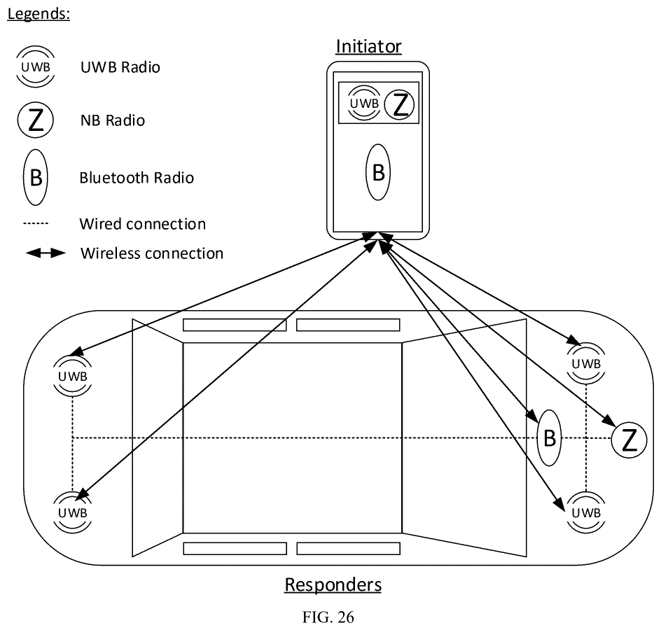

Another vehicle digital key application scenario illustrated in FIG. 26 is taken as example 3. The key difference here is that the NB radio and UWB radio are not housed together in a single module. Multiple UWB radios are located at various positions in a vehicle (e.g., a car) and act as responders. A single Bluetooth radio and a single NB radio are also present. All radios are connected with each other with wired links. The UWB radios in the car act as responders. Initiator device (e.g., smartphone) contains one each of the UWB, NB and Bluetooth radios. In case the NB radio is absent, this reduces to a UWB-only one-to-many ranging scenario in which both the control frames as well as the ranging packets are transmitted using UWB radios.

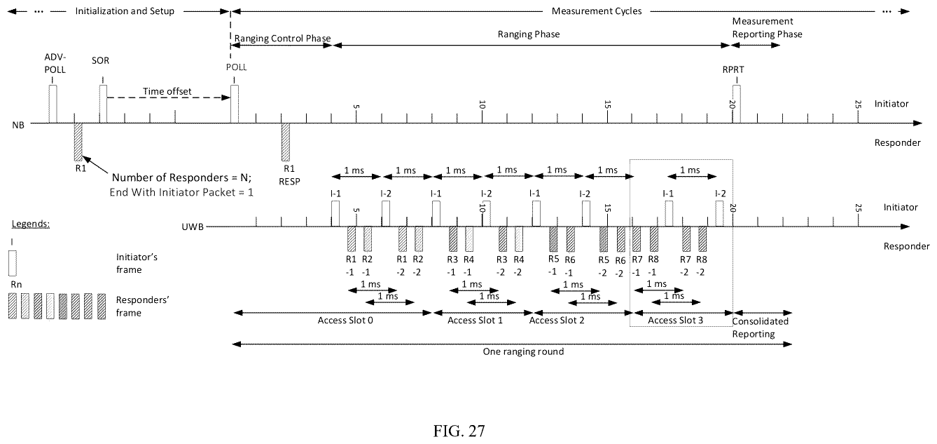

An example time domain message flow of a one-to-many UWB MMS ranging application that is adapted for DS-TWR with multiple coordinated responders and a proxy-responder is illustrated in FIG. 27. The message flow is similar to that illustrated in FIG. 9 and FIG. 22 and have been described earlier and are not repeated here. Only the aspects that are unique to this scenario are described. The initialization and setup phase is the same as in example 2 and since there is a single NB radio shared among all responders, all NB control frames are transmitted by the same radio. The key difference is in the ranging phase in which the time efficient one-to-many ranging mode is utilized (i.e., Ranging mode field is set to 2). As compared to example 1, in each access slot the initiator's MMS packet is interleaved with multiple (e.g., two) responders' MMS packets.

In this case, the timing measurements to enable DS-TWR are performed in the same manner as explained in example 1, except that when RSF-only MMS packets are used, instead of getting the initiator to transmit an additional MMS packet, the responder can request the initiator to reverse the transmission sequence of the last MMS packet (in the last access slot), i.e., the fragment interleaving is reversed (responder transmits first, followed by the initiator). This enables DS-TWR measurements for the last set of responders as well regardless of the type of the MMS packet. It can be seen from FIG. 27 that one measurement cycle can be completed in 22 slots (i.e., 11 ms), which is even shorter than the time required for one measurement cycle in example 2.

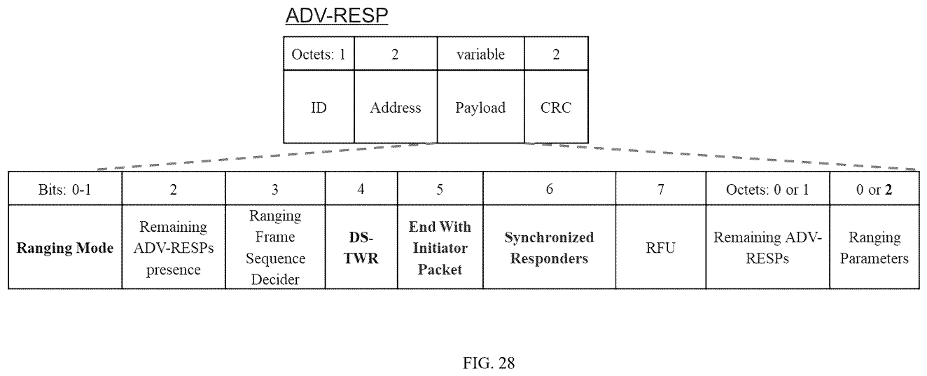

The responders can request the initiator to reverse the transmission sequence of the last MMS packet by setting the End With Initiator Packet field to 1 in the ADV-RESP frame as illustrated in FIG. 28. The Synchronized Responders field indicates that the N responders requested for the one-to-many ranging (as indicated the Ranging Mode field) are synchronized with each other. When the initiator receives an ADV-RESP frame with the Synchronized Responders field set to 1, and if the Remaining ADV-RESPs field is absent in the ADV-RESP frame, the initiator will understand that this is the only ADV-RESP frame transmitted by any one of the N responders and it can proceed to transmit the SOR frame upon receiving the ADV-RESP frame.

Alternatively, when DS-TWR is requested, and RSF-only MMS packets are used for the MMS ranging, the initiator may decide on its own to reverse the transmission sequence of the last MMS packet.

If Mixed MMS packets or RIF-only MMS packets are used, the fragments of the interleaved MMS packet from the initiator and responders are used for timing computation for DS-TWR (same as example 1). When Mixed MMS packets or RIF-only MMS packets are used for MMS ranging, a single MMS packet exchange is enough for DS-TWR. The initiator records the timing of the concerned RMARKERs and computes the required times (Round-trip time (Tround1_Rn), Reply time (Treply2_Rn)) for each responder as described in example 1. Each of the responders records the timing of the concerned RMARKERs and computes the required times (Reply time (Treply1_Rn), Round-trip time (Tround2_Rn)) as described in example 1.

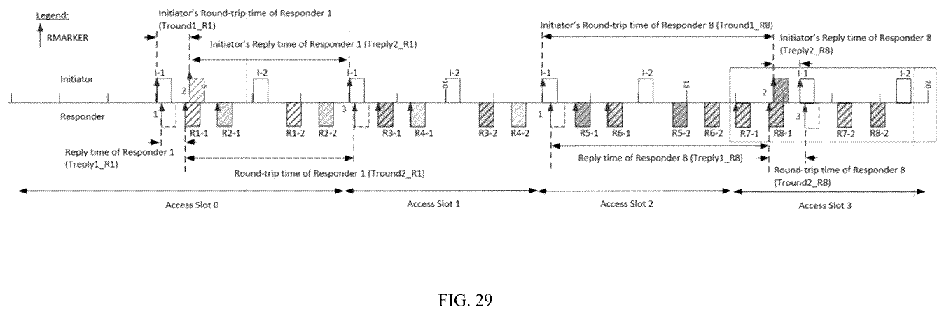

However, if MMS packets with a single fragment with RMARKER (e.g., RSF-only MMS packets or RIF-Only MMS Packet with a single fragment) are used, the first RMARKER in the first fragment of the immediately preceding MMS Packet from the initiator, and the first RMARKER in the first fragment of the immediately succeeding MMS packet from the initiator are used as the first and third RMARKERs respectively, while the first RMARKER in the first fragment of the responder's MMS packet is used as the second RMARKER for all timing computation for DS-TWR. This illustrated in FIG. 29. In this case, only the first fragment of the MMS packets contain RMARKERs that can be used to make timing measurements, while three RMARKERs are required to make timing measurements for DS-TWR. For all responders except the last responder, the first RMARKER is the RMARKER in the first fragment of the initiator's MMS packet for the responder, the second RMARKER is the RMARKER in the first fragment of the responder's MMS packet for the initiator, while the third RMARKER is the RMARKER in the first fragment of the initiator's MMS packet for the next group of responders. This is illustrated in the left half of FIG. 29. However, for the last group of responders, since the transmission sequence of the last MMS packet is reversed, the first RMARKER is the RMARKER in the first fragment of the initiator's MMS packet for the previous group of responders (e.g., the I-1 fragment at the beginning of access slot 2), the second RMARKER is the RMARKER in the first fragment of the responder's MMS packet for the initiator (e.g., R7-1 or R8-1 fragment), while the third RMARKER is the RMARKER in the first fragment of the last MMS packet from the initiator (e.g., the I-1 in access slot 3). This is illustrated in the right half of FIG. 29.

When the DS-TWR is requested (i.e., the DS-TWR bit is set to 1 in the applicable frames), both the Round-trip Time field and the Reply Time field are included in the measurement report(s), else the initiator's measurement report only includes the Round-trip time and the responder's measurement report only includes the Reply time. Once a device (initiator or responder) receives the measurement reports from the peer device, it can compute the DS-TWR TOF using Equation 1, and hence estimate the range of the peer device.

This method of enabling DS-TWR timing measurements for the last responder when MMS packets with a single fragment with RMARKER (e.g., RSF-only MMS packets or RIF-only MMS packet with a single fragment) are used, by reversing the transmission sequence of the last MMS packet (in the last access slot), i.e., the reversing the fragment interleaving (responder transmits first, followed by the initiator) is also applicable for the serial one-to-many ranging sequence described in example 1. Referring to the access slot 8 in FIG. 19, if the responder 8 transmits the first fragment of its MMS packet before the first fragment of the initiator's last MMS packet, the final MMS packet from the initiator is not necessary to make the DS-TWR measurements. Instead, to make the DS-TWR timing measurements, for the last responder the first RMARKER is the RSF-RMARKER (in the first RSF) of the initiator's MMS packet for the previous responder (e.g., responder 7) or the last responder's (e.g., responder 8) MMS packet for the initiator, while the second RMARKER is the RSF-RMARKER (in the first RSF) of the last MMS packet from the initiator.

Next, embodiments of products related to the communication method will be described.

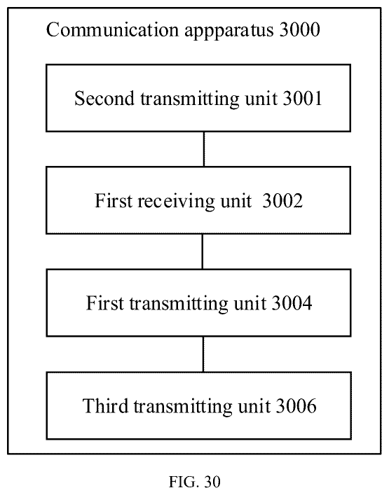

FIG. 30 illustrates a block diagram of a communication apparatus 3000 according to an embodiment of the present disclosure. The communication apparatus 3000 includes units to implement the operations or the processes in the method embodiments from the initiator side. As shown in FIG. 30, the apparatus 3000 includes:
a first receiving unit 3002, configured to receive an advertising-response (ADV-RESP) frame from a responder, where the ADV-RESP frame indicates a number N of the responder to participate in multi-millisecond (MMS) ranging, N≥1; and
a first transmitting unit 3004, configured to transmit a start of ranging (SOR) frame to the responder according to the ADV-RESP frame, where the SOR frame is used to provide a time offset at which a first range-measurement cycle to start.

In an embodiment, the ADV-RESP frame includes a first indication, and the first indication is used to indicate the number N.

In an embodiment, the ADV-RESP frame includes a second indication, and the second indication is used to indicate a number of a remaining ADV-RESP frame to be transmitted following the ADV-RESP frame, the number of the remaining ADV-RESP frame comprised in an i-th ADV-RESP frame is N−i, and 1≤i≤N.

In an embodiment, the number N is indicated by a number of the ADV-RESP frame received by the initiator.

In an embodiment, N≥2, the first receiving unit 3002 is configured to: sequentially receive N ADV-RESP frames from N responders according to a predetermined order, where the predetermined order is coordinated by the N responders.

In an embodiment, the ADV-RESP frame includes a first indication and a second indication, the first indication is used to indicate the number N, and the second indication is used to indicate a number of a remaining ADV-RESP frame to be transmitted following the ADV-RESP frame, the number of the remaining ADV-RESP frame included in an i-th ADV-RESP frame is N−i, and 1≤i≤N.

In an embodiment, N≥2, the ADV-RESP frame further includes a third indication, and the third indication is used to indicate N responders are synchronized with each other.

In an embodiment, the first receiving unit 3002 is configured to: receive one ADV-RESP frame from one responder, where the one responder is predetermined or dynamically selected from the responder to participate in the MMS ranging.

In an embodiment, the apparatus 3000 further includes: a second transmitting unit 3001, configured to transmit an advertising-poll (ADV-POLL) frame to the responder, where the ADV-POLL frame is used to indicate a maximum number of K responder supported for the MMS ranging, and K≥1.

In an embodiment, the first transmitting unit 3004 is configured to: transmit the SOR frame to the responder upon receiving an N-th ADV-RESP frame.

In an embodiment, the first transmitting unit 3004 is configured to: estimate an expected transmission time of N ADV-RESP frame; and transmit the SOR frame to the responder upon elapse of the expected transmission time.

In an embodiment, the first transmitting unit 3004 is configured to: transmit the SOR frame to the one responder.

In an embodiment, the apparatus 3000 further includes a unit configured to: determine a number M of a responder for MMS ranging according to a number of received ADV-RESP frame, MEN; and transmit the SOR frame including a fourth indication indicating the number M.

In an embodiment, the ADV-RESP frame further includes a fifth indication for indicating that a POLL frame is absent in a ranging control phase other than in a first access slot in the MMS ranging.

In an embodiment, the ADV-RESP frame further includes a sixth indication for indicating that an RESP frame is absent in the ranging control phase other than in the first access slot.

In an embodiment, the ADV-RESP frame further includes a seventh indication for indicating that the initiator is requested to transmit a measurement report; the apparatus 3000 further includes a third transmitting unit 3006 configured to transmit a report frame.

In an embodiment, N≥2, and the ADV-RESP frame further includes an eighth indication for requesting a consolidated measurement report; the apparatus further includes a generating unit, configured to generate the consolidated measurement report according to measurements for N responders; and the third transmitting unit 3006 is configured to transmit the report frame carrying the consolidated measurement report.

In an embodiment, the ADV-RESP frame further includes a ninth indication for requesting a double-sided two-way ranging (DS-TWR) measurement in a measurement report, and a seventh indication for indicating that the initiator is requested to transmit a measurement report is comprised in the ADV-RESP frame; the apparatus further includes a unit configured to transmit the measurement report comprising both a first round-trip time and a first reply time.

In an embodiment, the ADV-RESP frame further includes a tenth indication for requesting the initiator to transmit an additional MMS packet; the method apparatus further includes a unit configured to transmit the additional MMS packet.

In an embodiment, an additional MMS packet is not requested in the ADV-RESP frame; the apparatus further includes units configured to: determine an MMS packet used for the MMS ranging is an MMS packet including a single fragment with a ranging marker; set an eleventh indication for requesting the initiator to transmit an additional MMS packet in the SOR frame to be valid; and transmit the additional MMS packet.

In an embodiment, the apparatus further includes units configured to: record a first transmission time of a first ranging marker of a first fragment of a first MMS packet from the initiator to an N-th responder, a first reception time of a second ranging marker of a first fragment of a second MMS packet from the N-th responder to the initiator, and a second transmission time of a third ranging marker of a first fragment of the additional MMS packet; and compute the first round-trip time and the first reply time according to the first transmission time, the first reception time, and the second transmission time.

In an embodiment, the ADV-RESP frame further includes a twelfth indication for requesting to reverse fragment interleaving in a last access slot in the MMS ranging; the apparatus further includes a unit configured to transmit an MMS packet in the last access slot after receiving a first fragment of an MMS packet transmitted by an N-th responder.

In an embodiment, reversing of fragment interleaving in a last access slot in the MMS ranging is not requested in the ADV-RESP frame; the apparatus further includes units configured to: determine an MMS packet used for the MMS ranging is an MMS packet comprising a single fragment with a ranging marker; set a thirteenth indication for requesting to reverse fragment interleaving in a last access slot in the MMS ranging in the SOR frame to be valid; and transmit an MMS packet in the last access slot after receiving a first fragment of an MMS packet transmitted by an N-th responder.

In an embodiment, the apparatus further includes units configured to: record a third transmission time of a first ranging marker of a first fragment of a first MMS packet from the initiator to an (N−1)-th responder, a second reception time of a second ranging marker of a first fragment of a second MMS packet from the N-th responder to the initiator, and a fourth transmission time of a third ranging marker of a first fragment of a third MMS packet from the initiator to the N-th responder; and compute the first round-trip time and the first reply time according to the third transmission time, the second reception time, and the fourth transmission time.

In an embodiment, the apparatus further includes units configured to: record a fifth transmission time of a first ranging marker of a first fragment of a first MMS packet from the initiator to an m-th responder, a third reception time of a second ranging marker of a first fragment of a second MMS packet from the m-th responder to the initiator, and a sixth transmission time of a third ranging marker of a first fragment of a third MMS packet from the initiator to an (m+1)-th responder, 1≤m<N; and compute the first round-trip time and the first reply time according to the fifth transmission time, the third reception time, and the sixth transmission time.

In an embodiment, an MMS packet from the initiator is skipped in an access slots other than a first access slot and a last access slot in the MMS ranging, the apparatus further includes a unit configured to transmit a final MMS packet in a last access slot in the MMS ranging.

In an embodiment, N is even; the apparatus further includes units configured to: determine an MMS packet used for the MMS ranging is an MMS packet comprising a single fragment with a ranging marker; and transmit the final MMS packet in the last access slot in the MMS ranging after receiving a first fragment of a MMS packet transmitted by an N-th responder.

In an embodiment, the apparatus further includes units configured to: record a seventh transmission time of a first ranging marker of a first fragment of a first MMS packet from the initiator in a first access slot, a fourth reception time of a second ranging marker of a first fragment of a second MMS packet from the N-th responder to the initiator, and an eighth transmission time of a third ranging marker of a first fragment of a third MMS packet from the initiator in a last access slot; and compute the first round-trip time and the first reply time according to the seventh transmission time, the fourth reception time, and the eighth transmission time.

In an embodiment, the apparatus further includes units configured to: determine an MMS packet used for the MMS ranging is an MMS packet comprising at least two fragments with a ranging marker; record a ninth transmission time of a first ranging marker of a first fragment of a first MMS packet from the initiator to an n-th responder, a fifth reception time of a second ranging marker of a first fragment of a second MMS packet from the n-th responder to the initiator, and a tenth transmission time of a third ranging marker of a second fragment of the first MMS packet that carries a ranging marker, 1≤n≤N; and compute the first round-trip time and the first reply time according to the ninth transmission time, the fifth reception time, and the tenth transmission time.

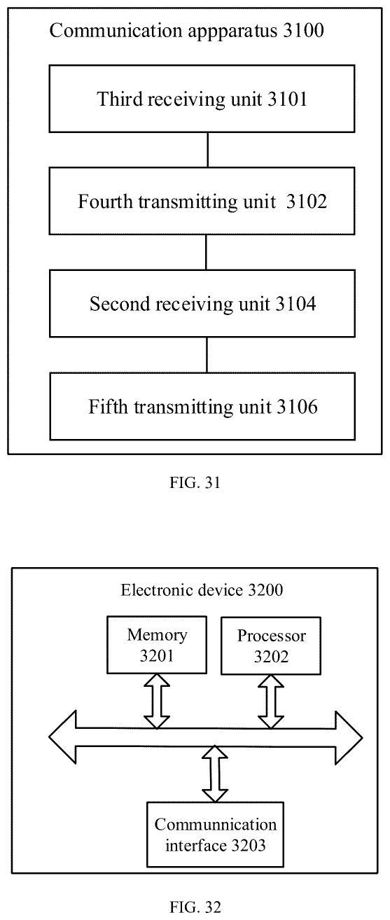

FIG. 31 illustrates a block diagram of a communication apparatus 3100 according to another embodiment of the present disclosure. The communication apparatus 3100 includes modules to implement the operations or the processes in the method embodiments from the initiator side. As shown in FIG. 31, the apparatus 3100 includes:
a fourth transmitting unit 3102, configured to transmit an advertising-response (ADV-RESP) frame to an initiator, where the ADV-RESP frame indicates a number N of the responder to participate in multi-millisecond (MMS) ranging, N≥1; and
a second receiving unit 3104, configured to receive a start of ranging (SOR) frame from the initiator, where the SOR frame is used to provide a time offset at which a first range-measurement cycle to start.

In an embodiment, the ADV-RESP frame includes a first indication, and the first indication is used to indicate the number N.

In an embodiment, the ADV-RESP frame includes a second indication, and the second indication is used to indicate a number of a remaining ADV-RESP frame to be transmitted following the ADV-RESP frame, the number of the remaining ADV-RESP frame comprised in an i-th ADV-RESP frame is N−i, and 1≤i≤N.

In an embodiment, the number N is indicated by a number of the ADV-RESP frame transmitted by the responder.

In an embodiment, N≥2, the apparatus further includes a coordinating unit configured to coordinate a predetermined order for transmitting N ADV-RESP frames; and the ADV-RESP transmitting unit is configured to sequentially transmit N ADV-RESP frames to the initiator according to the predetermined order.

In an embodiment, the ADV-RESP frame includes a first indication and a second indication, the first indication is used to indicate the number N, and the second indication is used to indicate a number of a remaining ADV-RESP frame to be transmitted following the ADV-RESP frame, the number of the remaining ADV-RESP frame included in an i-th ADV-RESP frame is N−i, and 1≤i≤N.

In an embodiment, N≥2, the ADV-RESP frame further includes a third indication, and the third indication is used to indicate N responders are synchronized with each other.

In an embodiment, the ADV-RESP transmitting unit is configured to transmit one ADV-RESP frame to the initiator, where the one ADV-RESP frame is transmitted by one responder which is predetermined or dynamically selected from the responder to participate in the MMS ranging.

In an embodiment, the apparatus 3100 further includes a third receiving unit 3101, configured to receive an advertising-poll (ADV-POLL) frame from the initiator, where the ADV-POLL frame is used to indicate a maximum number of K responder supported for the MMS ranging, and K≥1.

In an embodiment, the second receiving unit 3104 is configured to receive the SOR frame including a fourth indication indicating a number M of a responder for MMS ranging, MEN.

In an embodiment, the ADV-RESP frame further includes a fifth indication for indicating that a POLL frame is absent in a ranging control phase other than in a first access slot in the MMS ranging.

In an embodiment, the ADV-RESP frame further includes a sixth indication for indicating that an RESP frame is absent in the ranging control phase other than in the first access slot.

In an embodiment, the ADV-RESP frame further includes a fourteenth indication for indicating that the responder is requested to transmit a measurement report, the apparatus 3100 further includes a fifth transmitting unit 3106, configured to transmit a report frame.

In an embodiment, the ADV-RESP frame further includes an eighth indication for requesting a consolidated measurement report; the apparatus further includes: a collecting unit, configured to collect measurement reports from N responders; a generating unit, configured to generate the consolidated measurement report according to the measurement reports from the N responders; and the fifth transmitting unit 3106 is configured to transmit the report frame carrying the consolidated measurement report.

In an embodiment, the ADV-RESP frame further includes a ninth indication for requesting a double-sided two-way ranging (DS-TWR) measurement in a measurement report, and a fourteenth indication for indicating that the responder is requested to transmit a measurement report is included in the ADV-RESP frame; the apparatus further includes a unit configured to transmit the measurement report comprising both a second round-trip time and a second reply time field.

In an embodiment, the ADV-RESP frame further includes a tenth indication for requesting the initiator to transmit an additional MMS packet; the apparatus further includes a unit configured to receive the additional MMS packet from the initiator.

In an embodiment, an additional MMS packet is not requested in the ADV-RESP frame, and an eleventh indication for requesting the initiator to transmit an additional MMS packet in the SOR frame is set to be valid when an MMS packet used for the MMS ranging is an MMS packet including a single fragment with a ranging marker.

In an embodiment, the apparatus further includes units configured to: record a sixth reception time of a first ranging marker of a first fragment of a first MMS packet from the initiator to the N-th responder, an eleventh transmission time of a second ranging marker of a first fragment of a second MMS packet from the N-th responder to the initiator, and a seventh reception time of a third ranging marker of a first fragment of the additional MMS packet; and compute the second round-trip time and the second reply time according to the sixth reception time, the eleventh transmission time, and the seventh reception time.

In an embodiment, the ADV-RESP frame further includes a twelfth indication for requesting to reverse fragment interleaving in a last access slot in the MMS ranging; the apparatus further includes units configured to: transmit a first fragment of an MMS packet to the initiator; and receive an MMS packet in a last access slot in the MMS ranging from the initiator.

In an embodiment, reversing of fragment interleaving in a last access slot in the MMS ranging is not requested in the ADV-RESP frame; a thirteenth indication for requesting to reverse fragment interleaving in a last access slot in the MMS ranging in the SOR frame is set to be valid when an MMS packet used for the MMS ranging is an MMS packet comprising a single fragment with a ranging marker; the apparatus further includes units configured to: transmit a first fragment of a MMS packet to the initiator; and receive an MMS packet in a last access slot in the MMS ranging from the initiator.

In an embodiment, the apparatus further includes units configured to: record an eighth reception time of a first ranging marker of a first fragment of a first MMS packet from the initiator to an (N−1)-th responder, a twelfth transmission time of a second ranging marker of a first fragment of a second MMS packet from the N-th responder to the initiator, and a ninth reception time of a third ranging marker of a first fragment of a third MMS packet from the initiator to the N-th responder; and compute the second round-trip time and the second reply time according to the eighth reception time, the twelfth transmission time, and the ninth reception time.

In an embodiment, the apparatus further includes units configured to: record a tenth reception time of a first ranging marker of a first fragment of a first MMS packet from the initiator to the m-th responder, a thirteenth transmission time of a second ranging marker of a first fragment of a second MMS packet from the m-th responder to the initiator, and an eleventh reception time of a third ranging marker of a first fragment of a third MMS packet from the initiator to an (m+1)-th responder, 1≤m<N; and compute the second round-trip time and the second reply time according to the tenth reception time, the thirteenth transmission time, and the eleventh reception time.

In an embodiment, an MMS packet from the initiator is skipped in an access slots other than a first access slot and a last access slot in the MMS ranging, the apparatus further includes a unit configured to receive a final MMS packet in a last access slot in the MMS ranging.

In an embodiment, N is even, and an MMS packet used for the MMS ranging is an MMS packet comprising a single fragment with a ranging marker; the apparatus further includes units configured to: transmit a first fragment of a MMS packet to the initiator; and receive the final MMS packet in a last access slot in the MMS ranging from the initiator.

In an embodiment, the apparatus further includes units configured to: record a twelfth reception time of a first ranging marker of a first fragment of a first MMS packet from the initiator in a first access slot, a fourteenth transmission time of a second ranging marker of a first fragment of a second MMS packet from the N-th responder to the initiator, and a thirteenth reception time of a third ranging marker of a first fragment of a third MMS packet from the initiator in a last access slot; and compute the second round-trip time and the second reply time according to the twelfth reception time, the fourteenth transmission time, and the thirteenth reception time.

In an embodiment, an MMS packet used for the MMS ranging is an MMS packet comprising at least two fragments with a ranging marker; the apparatus further includes units configured to: record a fourteenth reception time of a first ranging marker of a first fragment of a first MMS packet from the initiator to the n-th responder, a fifteenth transmission time of a second ranging marker of a first fragment of a second MMS packet from the n-th responder to the initiator, and a fifteenth reception time of a third ranging marker of a second fragment of the first MMS packet that carries a ranging marker, 1≤n≤N; and compute the second round-trip time and the second reply time according to the fourteenth reception time, the fifteenth transmission time, and the fifteenth reception time.

It should be understood by a person skilled in the art that, the relevant description of the above units in the embodiments of the present disclosure may be understood with reference to the relevant description of the communication method in the embodiments of the present disclosure. It should be noted that the units involved in the embodiments of the present disclosure may be implemented through software or hardware. The name of a unit does not constitute a limitation to the unit itself. For example, the first transmitting unit 3004, the second transmitting unit 3001, the third transmitting unit 3006, the fourth transmitting unit 3102 and the fifth transmitting unit 3106 may be implemented as the same transmitter. For another example, the first receiving unit 3002, the second receiving unit 3104 and the third receiving unit 3101 may be implemented as the same receiver. In addition, the function of a transmitter and a receiver may be implemented through a transceiver. Further, the functions implemented by multiple units may be implemented by one unit, which may be designed according to actual needs.

The present disclosure further provides an electronic device, as shown in FIG. 32, the electronic device 3200 may include a memory 3201 and a processor 3202, where a computer program is stored in the memory 3201, and configured to be executed by the processor 3202 to implement the corresponding operations described in the method embodiments. The relevant description of the operations may be understood with reference to the relevant description of the communication method in the embodiments of the present disclosure. In addition, the electronic device 3200 may further include a communication interface 3203 for communicating with other devices. The computer program (also known as programs, software, software applications, or codes) include machine instructions for a programmable processor, and may be implemented using high-level procedural and subtended programming languages, or assembly/machine languages.

The present disclosure further provides a communication system including the device configured to perform the communication method at the initiator side and the device configured to perform the communication method at the responder side.

The present disclosure further provides a computer-readable storage medium, where the computer readable storage medium stores computer execution instructions, and when the computer execution instructions are executed by a processor, the above mentioned communication method is implemented.

The present disclosure further provides a computer program product including computer execution instructions, where when the computer execution instructions are executed by a processor, the above mentioned communication method is implemented.

By way of example, and not limiting, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

1. A communication method, comprising:
receiving, by an initiator, an advertising-response (ADV-RESP) frame from a responder, wherein the ADV-RESP frame is used by the responder to request a ranging mode for multi-millisecond (MMS) ranging; and
transmitting, by the initiator, a start of ranging (SOR) frame to the responder according to the ADV-RESP frame.

2. The method according to claim 1, wherein the ADV-RESP frame comprises a first ranging mode field indicating the ranging mode requested for the MMS ranging.

3. The method according to claim 2, wherein a value of the first ranging mode field is any one of 0, 1 or 2; and wherein the value of 0 indicates one-to-one ranging, the value of 1 indicates serial one-to-many ranging, and the value of 2 indicates time efficient one-to-many ranging.

4. The method according to claim 2, wherein the SOR frame comprises a second ranging mode field that is used for confirming the ranging mode requested for the MMS ranging.

5. The method according to claim 4, wherein a value of the second ranging mode field is any one of 0, 1 or 2; and wherein the value of 0 indicates one-to-one ranging, the value of 1 indicates serial one-to-many ranging, and the value of 2 indicates time efficient one-to-many ranging.

6. The method according to claim 1, wherein before the receiving the ADV-RESP frame from the responder, the method further comprises:
transmitting, by the initiator, an advertising-poll (ADV-POLL) frame to the responder, wherein the ADV-POLL frame is used to indicate a maximum number of K responder supported for the MMS ranging, and K≥1.

7. A communication method, comprising:
transmitting, by a responder, an advertising-response (ADV-RESP) frame to an initiator, wherein the ADV-RESP frame is used for requesting a ranging mode for multi-millisecond (MMS) ranging; and
receiving, by the responder, a start of ranging (SOR) frame from the initiator.

8. The method according to claim 7, wherein the ADV-RESP frame comprises a first ranging mode field indicating the ranging mode requested for the MMS ranging.

9. The method according to claim 8, wherein a value of the first ranging mode field is any one of 0, 1 or 2; and wherein the value of 0 indicates one-to-one ranging, the value of 1 indicates serial one-to-many ranging, and the value of 2 indicates time efficient one-to-many ranging.

10. The method according to claim 8, wherein the SOR frame comprises a second ranging mode field that is used for confirming the ranging mode requested for the MMS ranging.

11. The method according to claim 10, wherein a value of the second ranging mode field is any one of 0, 1 or 2; and wherein the value of 0 indicates one-to-one ranging, the value of 1 indicates serial one-to-many ranging, and the value of 2 indicates time efficient one-to-many ranging.

12. The method according to claim 7, wherein before the transmitting the ADV-RESP frame to the initiator, the method further comprises:
receiving, by the responder, an advertising-poll (ADV-POLL) frame from the initiator, wherein the ADV-POLL frame is used to indicate a maximum number of K responder supported for the MMS ranging, and K≥1.

13. An electronic device, comprising:
one or more processors; and
a non-transitory computer-readable storage medium coupled to the one or more processors and storing programming for execution by the processors, wherein the programming, when executed by the one or more processors, configures the electronic device to:
receive an advertising-response (ADV-RESP) frame from a responder, wherein the ADV-RESP frame is used by the responder to request a ranging mode for multi-millisecond (MMS) ranging; and
transmit a start of ranging (SOR) frame to the responder according to the ADV-RESP frame.

14. The device according to claim 13, wherein the ADV-RESP frame comprises a first ranging mode field indicating the ranging mode requested for the MMS ranging.

15. The device according to claim 14, wherein a value of the first ranging mode field is any one of 0, 1 or 2; and wherein the value of 0 indicates one-to-one ranging, the value of 1 indicates serial one-to-many ranging, and the value of 2 indicates time efficient one-to-many ranging.

16. The device according to claim 14, wherein the SOR frame comprises a second ranging mode field, the second ranging mode field is used for confirming the ranging mode requested for the MMS ranging.

17. The device according to claim 16, wherein a value of the second ranging mode field is any one of 0, 1 or 2; and wherein the value of 0 indicates one-to-one ranging, the value of 1 indicates serial one-to-many ranging, and the value of 2 indicates time efficient one-to-many ranging.

18. The device according to claim 13, wherein the electronic device is further configured to:
transmit an advertising-poll (ADV-POLL) frame to the responder, wherein the ADV-POLL frame is used to indicate a maximum number of K responder supported for the MMS ranging, and K≥1.
